(19) United States
(12) Patent Application Publication
(10) Pub. No.: US 2024/0066719 A1
(43) Pub. Date: Feb. 29, 2024

(54) END EFFECTOR

(71) Applicant: YAMAHA HATSUDOKI KABUSHIKI KAISHA, Iwata-shi (JP)

(72) Inventor: Yoshinori HARADA, Shizuoka (JP)

(21) Appl. No.: 18/505,922

(22) Filed: Nov. 9, 2023

Related U.S. Application Data
(63) Continuation of application No. PCT/JP2022/019978, filed on May 11, 2022.

(51) Int. Cl. B25J 15/00; B25J 9/06

(52) U.S. Cl. CPC B25J 15/0028; B25J 9/06; A01G 3/02

(57) ABSTRACT

An end effector includes: a target-object-positioning mechanism provided at a body member and including a first contact-move member, a second contact-move member and an opening-closing member that make contact with a part of a target object and position a portion of the target object at a processing position; and a processing mechanism provided at the body member and processing the portion of the target object positioned at the processing position. The first contact-move member and the second contact-move member intersect each other inside the opening-closing member. Portions forward of the intersection portion in the first and second contact-move members make contact with the opening-closing member by an elastic restoring force of an elastic member. The opening-closing member, when moved from a rear position to a front position, applies a forward force to the first and second contact-move members so that they are moved in a direction approaching each other.

### CROSS-REFERENCES TO RELATED APPLICATIONS

This is a continuation-in-part application of International Application No. PCT/JP2022/019978 filed on May 11, 2022, the contents of which are incorporated herein by reference.

### TECHNICAL FIELD

The present teaching relates to an end effector.

### BACKGROUND ART

Fruits such as strawberries and grapes, and green and yellow vegetables such as asparagus and tomatoes, are delicate and prone to damage as well as have high unit prices, compared with grain such as rice and wheat. Such delicate crops with high unit prices are harvested manually one by one to prevent damage caused to the crops at the time of harvest. Therefore, harvesting, e.g., fruits and green and yellow vegetables, places a large physical burden on a producer, as compared with, e.g., grain that can be harvested efficiently on a large scale by using harvesting machines such as combine harvesters. The physically demanding harvesting operation involves difficulty in securing labor force. The harvesting operation, therefore, tends to place an increased burden on a producer. Thus, crop harvesting systems using a multi-joint robot arm are known.

For example, Patent Document 1 discloses a robotic harvesting system provided with a picking head (end effector) for harvesting a target object to be harvested such as a crop at the end of a multi-joint robot arm. The end effector described in Patent Document 1 has a hook for grabbing the target object, a gripper for gripping the target object, a cutter for cutting off the target object, and a camera for identifying the target object. The robotic harvesting system moves the hook along a predetermined circular arc by the multi-joint robot arm to allow the hook to grab the target object identified based on an image taken by the camera. The target object contacted by the hook is grabbed by a semicircular-shaped end portion of the hook when the hook moves along the circular arc. The robotic harvesting system cuts the target object grabbed by the hook, using the cutter, as well as grips the target object by the gripper.

For example, Patent Document 2 discloses an end effector attached to a work machine such as a multi-joint robot arm. The end effector has a support member supported by a movable work machine, and a target-object-positioning mechanism that positions a target object in a processing position. The target-object-positioning mechanism has a plurality of contact-move members that move in a front-rear direction and in directions orthogonal to the front-rear direction, with a direction from the support member toward the processing position as a forward direction. Proximal end portions of the plurality of contact-move members are supported by the support member. The plurality of contact-move members are configured to be accommodated within a tubular opening-closing member when the opening-closing member moves in the forward direction. Therefore, the end effector causes the opening-closing member to move in the forward direction to move the plurality of contact-move members in a direction approaching each other, thereby grabbing the target object.

### CITATION LIST

### Patent Document

Patent Document 1: International Patent Application Publication No. 2018/087546
Patent Document 2: International Patent Application Publication No. 2022/014641

### SUMMARY OF INVENTION

### Technical Problem

In order to move the hook along the circular arc, the robotic harvesting system of Patent Document 1 interlocks respective axes of the multi-joint robot arm that is a work machine for moving the end effector, with high precision. When the target object slightly moves due to external factors such as wind and rain, the robotic harvesting system interlocks the respective axes of the multi-joint robot arm with still higher precision, thereby increasing the rate of grabbing the target object. However, reduced speed of movement of the multi-joint robot arm with increased precision of the arm results in a lowered number of harvested target objects per unit of time in the robotic harvesting system. Thus, the precision of the multi-joint robot arm in moving the end effector affects the rate of grabbing the target object by the end effector.

The plurality of contact-move members provided in the end effector of Patent Document 2 are supported by the support member so as to be located apart from each other in directions orthogonal to a center line extending in the front-rear direction of the support member. The plurality of contact-move members extend in directions increasingly away from each other, toward the front. When the opening-closing member moves forward, the plurality of contact-move members are changed into a closed state in which they are located close to each other. When the opening-closing member moves rearward, the plurality of contact-move members are changed into an open state in which they are located apart from each other as their contact positions with the opening-closing member shift toward their proximal end portions.

The end effector has increased robustness so that a target object can be grabbed and processed even when a condition of a surrounding environment changes, by grabbing the target object through the plurality of contact-move members in the open state. However, an interval between distal end portions of the plurality of contact-move members is determined by an interval between the proximal end portion of each contact-move member and its contact position with the opening-closing member in a direction orthogonal to the front-rear direction. Therefore, the end effector with the plurality of contact-move members accommodated in the opening-closing member may be unable to increase the interval between the distal end portions of the plurality of contact-move members to the extent that the robustness for the target object is increased.

It is an object of the present teaching to provide an end effector with increased robustness so that a target object can be grabbed and processed even when a condition of a surrounding environment changes, without highly precisely moving a work machine that moves the end effector.

### Solution to Problem

The inventor of the present teaching studied an end effector that can increase the rate of grabbing a target object, while reducing the time required to move the end effector and the energy required to move the end effector, without highly precisely moving a work machine that moves the end effector. Through an intensive study, the inventor arrived at the configuration as described below.

An end effector according to one embodiment of the present teaching is movable by a work machine for grabbing a target object, and comprises: a body member configured to be supported by the work machine; a target-object-positioning mechanism provided at the body member, the target-object-positioning mechanism including a contact-move-member-moving mechanism configured to make contact with a part of the target object and to position a portion of the target object at a processing position; and a processing mechanism provided at the body member, and being configured to perform processing on the portion of the target object positioned at the processing position.

The contact-move-member-moving mechanism includes: a first contact-move member supported by the body member at a first support portion, the first contact-move member being configured to be movable, with respect to the body member, in an open-and-closed direction, which includes an open direction and a closed direction and which is orthogonal to a front-rear direction, the front-rear direction including a forward direction from the body member toward the processing position, and a rearward direction from the processing position toward the body member, the first contact-move member extending in the forward direction, and a second contact-move member supported by the body member at a second support portion, the second contact-move member being configured to be movable in the open-and-closed direction with respect to the body member, the second contact-move member extending in the forward direction. The target-object-positioning mechanism further includes: a tubular opening-closing member inside which a part of the first contact-move member and a part of the second contact-move member are located, the opening-closing member being supported by the body member, and being configured to be movable in the forward direction and the rearward direction with respect to the body member, the first contact-move member and the second contact-move member, an elastic member configured to apply a force to the first contact-move member and the second contact-move member to thereby cause a front end portion of the first contact-move member and a front end portion of the second contact-move member to move away from each other, and an opening-closing-member-moving mechanism configured to move the opening-closing member in the forward direction and the rearward direction between a rear position, corresponding to which the target object is positioned at the processing position, and a front position further forward than the rear position.

In a top view of the end effector, the first contact-move member and the second contact-move member intersect inside the opening-closing member at an intersection portion, which is further forward than the first and second support portions. Portions of the first contact-move member and the second contact-move member forward of the intersection portion are pressed to make contact with an inner circumferential surface of the opening-closing member respectively at a first contacted portion and a second contacted portion thereof facing each other, by an elastic restoring force of the elastic member.

The target-object-positioning mechanism is so configured that the intersection portion shifts in the forward direction with respect to the first and contact-move members when the front end portions of the first contact-move member and the second contact-move member move in the closed direction in which the front end portions approach each other, and the intersection portion shifts in the rearward direction with respect to the first and second contact-move members when the front end portions of the first and second contact-move members move in the open direction in which the front end portions move away from each other. The opening-closing member, when moved from the rear position to the front position by the opening-closing-member-moving mechanism, moves the front end portion of the first contact-move member in the closed direction to approach the front end portion of the second contact-move member by a force applied from the first contacted portion, and moves the front end portion of the second contact-move member in the closed direction to approach the front end portion of the first contact-move member by a force applied from the second contacted portion, to thereby bring the first and second contact-move members into contact with the target object with the intersection portion being shifted in the forward direction with respect to the first and second contact-move members.

As described above, the first contact-move member and the second contact-move member are configured to be movable in the open-and-closed direction with the open direction as a direction which is orthogonal to the front-rear direction and in which the first and second contact-move-members move away from each other, and the closed direction as a direction which is orthogonal to the front-rear direction and in which the first and second contact-move-members approach each other. The first contact-move member and the second contact-move member extend in the forward direction and toward each other from the first and second support portions, and intersect each other at positions further forward than the first and second support portions. Therefore, an interval in the open-and-closed direction between the first contacted portion and the first support portion, as well as an interval in the open-and-closed direction between the second contacted portion and the second support portion increase in proportion to an interval between the first support portion and the second support portion.

When the opening-closing member moves from the front position to the rear position, the first contact-move member and the second contact-move member move in the open direction in which they move away from each other. At this time, the intersection portion between the first contact-move member and the second contact-move member shifts in the rearward direction with respect to the first contact-move member and the second contact-move member. Therefore, with the movement of the opening-closing member from the front position to the rear position, the inclination of each of the first contact-move member and the second contact-move member to the front-rear direction increases in proportion to an interval in the open-and-closed direction between the first contacted portion and the first support portion, and an interval in the open-and-closed direction between the second contacted portion and the second support portion.

From the above, in the end effector of the present application, an interval between the front end portion of the first contact-move member and the front end portion of the second contact-move member, with the opening-closing member located at the rear position, is larger than an interval between the front end portions of the first and second contact-move members without intersecting each other inside the opening-closing member. The end effector is more likely to have the target object located between the first contact-move member and the second contact-move member even when the end effector is misaligned with the target object. This allows for increased robustness so that the target object can be grabbed and processed even when a condition of a surrounding environment changes, without highly precisely moving the work machine that moves the end effector.

In another aspect, the end effector of the present teaching preferably includes the following configuration. The first contact-move member includes a first proximal end portion extending from the first support portion s in a direction away from the second contact-move member with the opening-closing member positioned at the front position, and a first distal end portion extending from a front end portion of the first proximal end portion toward the second contact-move member and intersecting the second contact-move member in the top view of the end effector. The first contact-move member is so configured that the first support portion is rotatable with a first axis orthogonal to the front-rear direction and the open-and-closed direction. The second contact-move member includes a second proximal end portion extending from the second support portion in a direction away from the first contact-move member with the opening-closing member positioned at the front position, and a second distal end portion extending from a front end portion of the second proximal end portion toward the first contact-move member and intersecting the first contact-move member in the top view of the end effector. The second contact-move member is so configured that the second support portion is rotatable with a second axis orthogonal to the front-rear direction and the open-and-closed direction.

In a state where the opening-closing member is positioned at the front position, the first proximal end portion of the first contact-move member is, with the open-and-closed direction as the left-right direction, located at the right of a reference line that passes through the center between the first contact-move member and the second contact-move member and extends in the front-rear direction, for example. In this case, the first distal end portion of the first contact-move member extends from the right toward the left of the reference line. Similarly, with the opening-closing member positioned at the front position, the second proximal end portion of the second contact-move member is located at the left of the reference line. The second distal end portion of the second contact-move member extends from the left toward the right of the reference line.

The front end portion of the first distal end portion located at the left of the reference line and the front end portion of the second distal end portion located at the right of the reference line rotate away from each other with the first axis and the second axis as their rotation centers, respectively. The front end portion of the first proximal end portion rotates from the right toward the left of the reference line. The front end portion of the second proximal end portion rotates from the left toward the right of the reference line. The amount of rotation of each of the first contact-move member and the second contact-move member increases because they intersect each other in the opening-closing member. This allows for increased robustness so that the target object can be grabbed and processed even when a condition of a surrounding environment changes, without highly precisely moving the work machine that moves the end effector.

In another aspect, the end effector of the present teaching preferably includes the following configuration. The opening-closing member, when moved from the rear position to the front position by the opening-closing-member-moving mechanism, makes contact with the part of the target object together with the first contact-move member and the second contact-move member that are moved by the opening-closing member.

As described above, the first contact-move member, the second contact-move member and the opening-closing member make contact with the target object with the opening-closing member positioned at the front position. The first contact-move member and the second contact-move member make contact with the target object from the front. The opening-closing member makes contact with the target object from the rear. Therefore, the end effector grabs, by the first and second contact-move members and the opening-closing member, the target object that is in a posture facilitating processing of the processing mechanism even when the end effector is misaligned with the target object. This allows for increased robustness so that the target object can be grabbed and processed even when a condition of a surrounding environment changes, without highly precisely moving the work machine that moves the end effector.

In another aspect, the end effector of the present teaching preferably includes the following configuration. The first contact-move member and the second contact-move member are supported to be movable in the forward direction and the rearward direction with respect to the body member. The target-object-positioning mechanism includes the contact-move-member-moving mechanism for moving the first contact-move member and the second contact-move member in the forward direction and the rearward direction between the front position and the rear position. The first contact-move member and the second contact-move member are moved from the front position to the rear position by the contact-move-member-moving mechanism together with the opening-closing member when the opening-closing member is moved from the front position to the rear position by the opening-closing-member-moving mechanism.

As described above, the end effector moves the first contact-move member, the second contact-move member and the opening-closing member that are in contact with the target object, to the rear position to position the target object at the processing position. Therefore, the end effector moves the target object to the processing position by the first contact-move member, the second contact-move member and the opening-closing member while maintaining the target object in a posture that facilitates processing of the processing mechanism. That is, since the end effector draws the target object from the grabbing position to the processing position by the first contact-move member, the second contact-move member and the opening-closing member, interference between the processing mechanism and objects around the target object at the grabbing position can be suppressed.

The end effector moves the target object with the first contact-move member and the second contact-move member at their closest positions to each other, so that interference with other target objects and obstacles located around the target object is suppressed when the target object is positioned at the processing position. This allows for increased robustness so that the target object can be grabbed and processed even when a condition of a surrounding environment changes, without highly precisely moving the work machine that moves the end effector.

In another aspect, the end effector of the present teaching preferably includes the following configuration. The first contact-move member includes, at the front end portion thereof, a first claw portion bent toward the second contact-move member. The second contact-move member includes, at the front end portion thereof, a second claw portion bent toward the first contact-move member. With movement of the opening-closing member in the forward direction, the first claw portion and the second claw portion at least partially overlap each other when viewed in an axial direction of the first axis.

As described above, when the first contact-move member and the second contact-move member have surrounded and grabbed the target object, the first claw portion and the second claw portion are located adjacent to each other in the axial direction of the first axis. Therefore, the end effector moves the target object to the processing position with the target object supported by both the first claw portion and the second claw portion. The target object is held along a rearward-facing surface of the first claw portion and a rearward-facing surface of the second claw portion, so that the target object is positioned at the processing position in a posture that facilitates processing of the processing mechanism. In addition, since the first claw portion and the second claw portion are engaged with each other, the target object is less likely to be slipped from between the first claw portion and the second claw portion. Thus, the target object grabbed by the first contact-move member and the second contact-move member is less likely to be slipped from them, and can thereby be processed efficiently by the processing mechanism.

In another aspect, the end effector of the present teaching preferably includes the following configuration. A rear side surface of at least one of the first claw portion or the second claw portion at least partially overlaps an end surface of the opening-closing member when viewed in the front-rear direction.

As described above, at least one of the first claw portion or the second claw portion faces a front end surface of the opening-closing member. This allows for reliable positioning of the target object at the processing position by the front end surface of the opening-closing member and at least one of the first claw portion or the second claw portion.

In another aspect, the end effector of the present teaching preferably includes the following configuration. The first distal end portion includes a first guiding portion curved away from the second contact-move member. The second distal end portion includes a second guiding portion curved away from the first contact-move member. When the opening-closing member is moved with respect to the first contact-move member and the second contact-move member, the first guiding portion makes contact with the first contacted portion, and the second guiding portion makes contact with the second contacted portion.

As described above, a range in which the target object can be grabbed by the first contact-move member and the second contact-move member is increased by the first guiding portion and the second guiding portion which are curved away from each other. This allows for increased robustness so that the target object can be grabbed and processed even when a condition of a surrounding environment changes, without highly precisely moving the work machine that moves the end effector.

The terminology used herein is for the purpose of describing particular embodiments only and is not intended to be limiting of the invention.

As used herein, the term “and/or” includes any and all combinations of one or more of the associated listed items.

It will be further understood that the terms “including,” “comprising” or “having” and variations thereof when used in this specification specify the presence of stated features, steps, operations, elements, components, and/or their equivalents, but do not preclude the presence or addition of one or more steps, operations, elements, components, and/or groups thereof.

It will be further understood that the terms “mounted,” “connected,” “coupled,” and/or their equivalents are used broadly and encompass both direct and indirect mounting, connecting and coupling. Further, “connected” and “coupled” are not restricted to physical or mechanical connections or couplings, and can include electrical connections or couplings, whether direct or indirect.

Unless otherwise defined, all terms (including technical and scientific terms) used herein have the same meaning as commonly understood by one having ordinary skill in the art to which this invention belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention.

Embodiments of an end effector according to the present teaching will be herein described.

In the following description, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the FIGS. or description below.

[End Effector]

An end effector herein refers to a device for performing arbitrary processing on a target object. The end effector is attached to an end of a work machine such as a robot arm. The end effector has a configuration capable of performing processing on the target object, and includes various devices that enable the various types of processing.

[Target Object]

A target object herein refers to a target on which the end effector performs processing, such as a natural object, an artifact, a virus and a living thing (an animal, a plant). The target object specifically refers to, e.g., an agricultural product, a marine product, an industrial product, livestock, an insect and a human. The target object is an object including both a processing portion that is a portion processed by the end effector, and a contacted portion contacted by a contact part of the end effector to move the processing portion to a processing position. The target object includes, for example, a peduncle, a fruit, a trunk, a stem, a branch, a leaf, a stalk and a living thing in an agricultural product.

[Processing]

Processing herein refers to the work performed on the target object by the end effector. The processing includes, for example, physical processing, stimulation, operation, inspection and detection of the target object, such as grasping, suctioning, cutting, heating, cooling, marking, measuring, injecting and imaging the target object.

[Processing Mechanism]

A processing mechanism herein refers to a mechanism for performing processing on the target object in the end effector. The processing mechanism performs, e.g., physical processing, stimulation, operation, inspection and detection of the target object, such as grasping, suctioning, cutting, heating, cooling, marking, measuring, injecting and imaging the target object. The processing mechanism includes, for example, a grasping mechanism for grasping the target object, a suctioning mechanism for suctioning the target object, a cutting mechanism for cutting the target object, a heating-cooling mechanism for heating and cooling the target object, a marking mechanism for marking the target object and a measuring mechanism for measuring the target object.

[Target-Object-Positioning Mechanism]

A target-object-positioning mechanism herein refers to a mechanism for positioning the target object at the processing position in the end effector. The target-object-positioning mechanism has a function of grabbing the target object at a grabbing position. The target-object-positioning mechanism has a function of moving the grabbed target object from the grabbing position to the processing position. The target-object-positioning mechanism has a function of holding the target object.

[Processing Portion]

A processing portion herein refers to a portion of the target object on which the processing mechanism of the end effector performs the processing. The processing portion may be different from a contact portion contacted by contact-move members of the target-object-positioning mechanism, or may include a part of the contact portion.

[Processing Position]

A processing position herein refers to a position within the end effector at which the processing mechanism performs the processing on the target object in the end effector. The processing position is included in at least a part of a moving space of the contact-move members in the end effector.

[Intersection Portion]

An intersection portion herein refers to a portion at which parts of a plurality of components extending in different directions overlap each other when viewed in a predetermined direction, where the plurality of components are configured to be increasingly separated from each other toward one end portions and the other end portions from the overlapping portion.

### Advantageous Effects of Invention

According to one embodiment of the present teaching, it is possible to increase robustness so that the target object can be grabbed and processed even when a condition of a surrounding environment changes, without highly precisely moving the work machine that moves the end effector.

### BRIEF DESCRIPTION OF DRAWINGS

FIG. 1 is a perspective view of an end effector according to the present teaching, showing when contact-move members are located at a grabbing position and an opening-closing member is located at a rear position.

FIG. 2A is a cross-sectional view of the end effector taken along A-A line in FIG. 1.

FIG. 2B is a cross-sectional view of the end effector taken along B-B line in FIG. 2A.

FIG. 3 is a front view of a contact-move-member-moving mechanism of the end effector according to the present teaching.

FIG. 4 is a cross-sectional view of the end effector according to the present teaching taken along B-B line in FIG. 2A, showing when the contact-move-member-moving mechanism is located at the grabbing position and the opening-closing member is located at a front position.

FIG. 5 is a cross-sectional view of the end effector according to the present teaching taken along B-B line in FIG. 2A, showing when the contact-move-member-moving mechanism is located at a processing position and the opening-closing member is located at the rear position.

FIG. 6A is a cross-sectional view of the end effector taken along A-A line in FIG. 1.

FIG. 6B is a cross-sectional view of the end effector taken along C-C line in FIG. 6A.

FIG. 7A is a cross-sectional view of the end effector according to the present teaching taken along C-C line in FIG. 6A, showing when the contact-move-member-moving mechanism is located at the processing position and a processing blade moves in a forward direction.

FIG. 7B is a cross-sectional view of the end effector according to the present teaching taken along A-A line in FIG. 1, showing when the contact-move-member-moving mechanism is located at the processing position and the processing blade moves in the forward direction.

FIG. 8 is partial cross-sectional views of the end effector according to the present teaching, showing when the opening-closing member moves from the rear position to the front position with the contact-move-member-moving mechanism at the grabbing position.

FIG. 9 is partial cross-sectional views of the end effector according to the present teaching, showing when the contact-move-member-moving mechanism moves from the processing position to the grabbing position with the opening-closing member at the rear position.

FIG. 10 is a perspective view of a contact-move-member-moving space in the end effector according to a first embodiment of the present teaching.

FIG. 11 is a front view of the contact-move-member-moving mechanism in the contact-move-member-moving space of the end effector according to the first embodiment of the present teaching.

FIG. 12 is a cross-sectional view of the end effector according to the first embodiment of the present teaching taken along B-B line in FIG. 2A, showing when the contact-move-member-moving mechanism of the end effector is located at the grabbing position, a cross-sectional view of the end effector taken along B-B line in FIG. 2A, showing when the opening-closing member has moved to the front position with the contact-move-member-moving mechanism of the end effector at the grabbing position, and a cross-sectional view of the end effector taken along B-B line in FIG. 2A, showing when the contact-move-member-moving mechanism of the end effector has moved to the processing position.

### DESCRIPTION OF EMBODIMENTS

Embodiments will be described hereinafter with reference to the drawings. In the drawings, the same or corresponding parts are denoted by the same reference numerals, and description thereof will not be repeated. The dimensions of components in the drawings do not strictly represent, e.g., actual dimensions of the components and dimensional proportions of the components.

### First Embodiment

### Overall Configuration

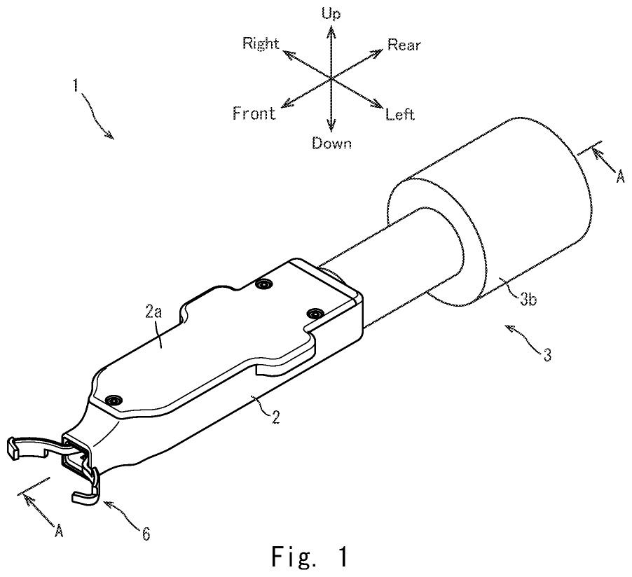

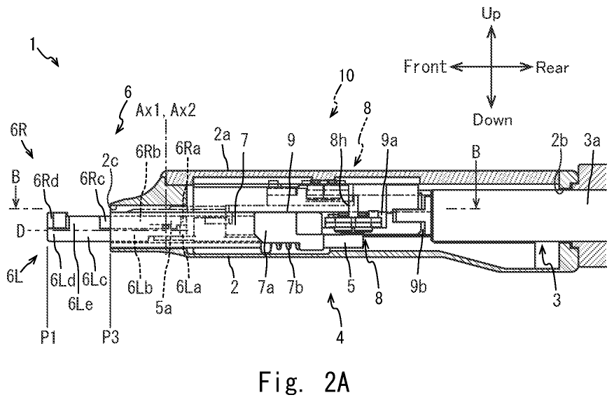

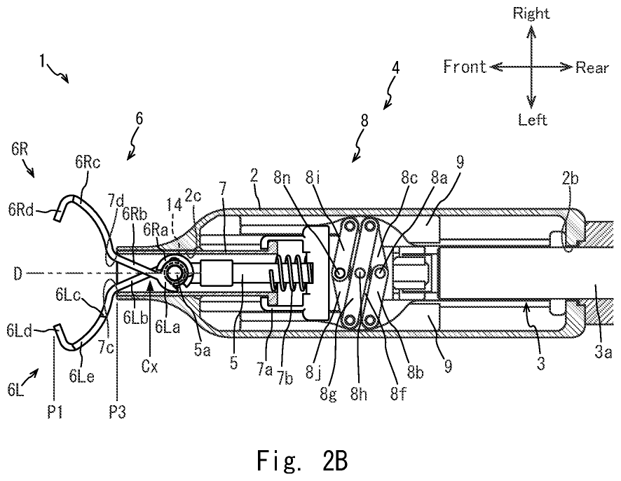

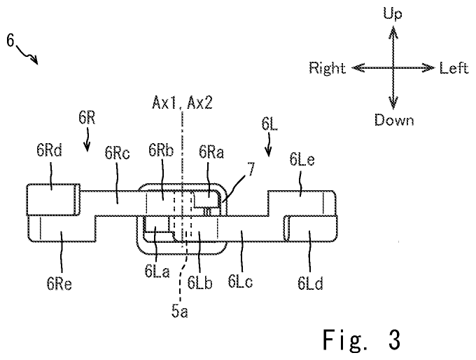

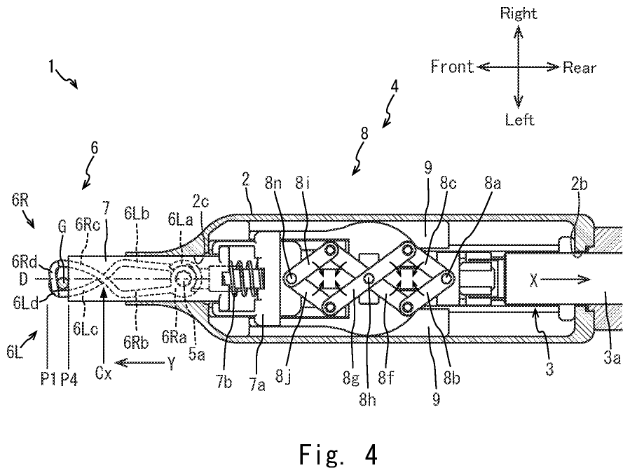

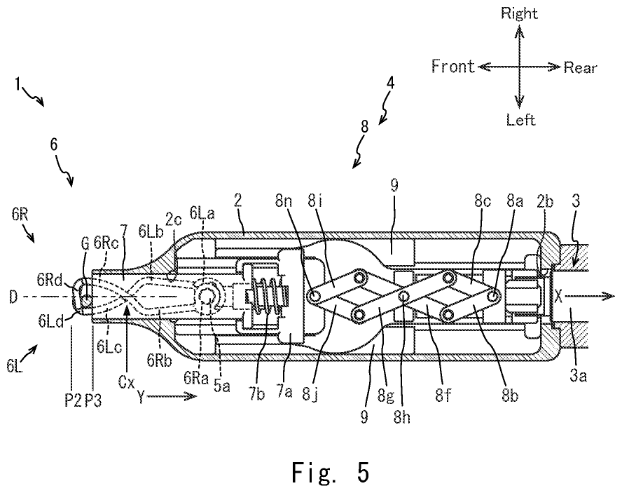

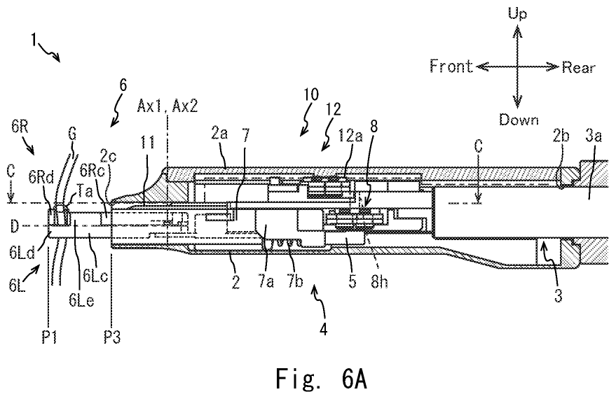

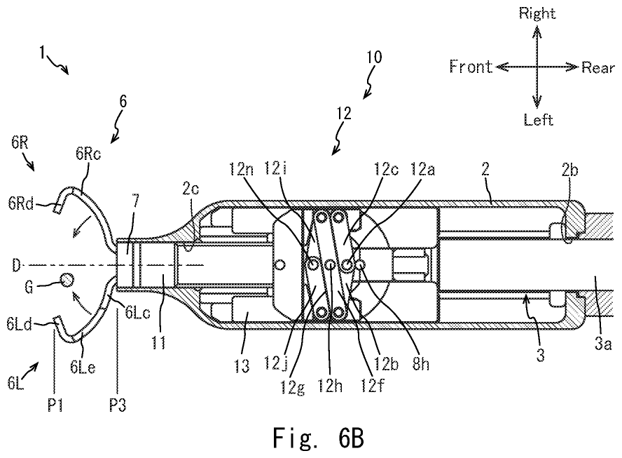

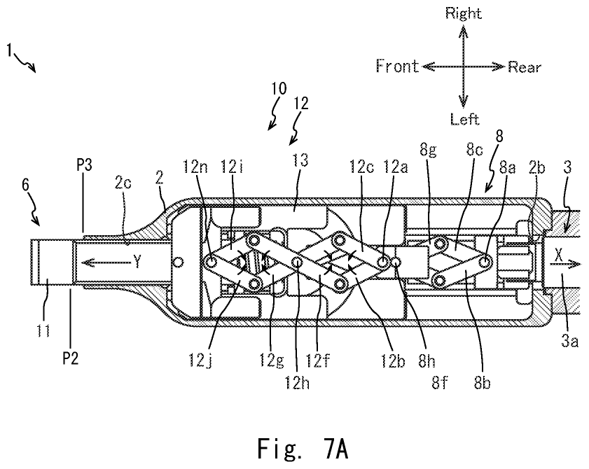

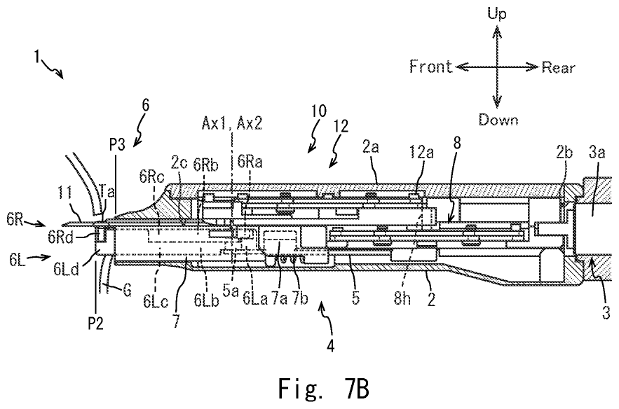

An end effector 1 according to a first embodiment of the present teaching will be described with reference to FIGS. 1 to 7B. FIG. 1 is a perspective view of the end effector 1 according to the present teaching. FIG. 2A is a cross-sectional view of the end effector 1 taken along A-A line in FIG. 1. FIG. 2B is a cross-sectional view of the end effector 1 taken along B-B line in FIG. 2A. FIG. 3 is a front view of a contact-move-member-moving mechanism 6. FIG. 4 is a cross-sectional view taken along B-B line in FIG. 2A, showing when the contact-move-member-moving mechanism 6 is located at a grabbing position P1 and an opening-closing member 7 is located at a front position P4. FIG. 5 is a cross-sectional view taken along B-B line in FIG. 2A, showing when the contact-move-member-moving mechanism 6 is located at a processing position P2 and the opening-closing member 7 is located at a rear position P3. FIG. 6A is a cross-sectional view of the end effector 1 taken along A-A line in FIG. 1. FIG. 6B is a cross-sectional view of the end effector 1 taken along C-C line in FIG. 6A. FIG. 7A is a cross-sectional view taken along C-C line in FIG. 6A, showing when the contact-move-member-moving mechanism 6 is located at the processing position P2 and a processing blade 11 moves in a forward direction. FIG. 7B is a cross-sectional view taken along A-A line in FIG. 1, showing when the contact-move-member-moving mechanism 6 is located at the processing position P2 and the processing blade 11 moves in the forward direction.

Hereinafter, arrow “Front” in the drawings indicates a forward direction of the end effector 1. Arrow “Rear” in the drawings indicates a rearward direction of the end effector 1. Arrow “Up” in the drawings indicates an upward direction of the end effector 1. Arrow “Down” in the drawings indicates a downward direction of the end effector 1. A front-rear direction of the end effector 1 is defined such that the forward direction of the end effector 1 is a direction in which a target-object-positioning mechanism 4 moves toward a grape stem G (hereinafter referred to as “stem G”), i.e., the processing blade 11 of a processing mechanism 10 moves from a body member 2 toward the processing position P2. A left-right direction of the end effector 1 is a direction orthogonal to the front-rear direction and an up-down direction of the end effector 1, where the vertical direction is defined as the up-down direction. In the following embodiments, “clockwise” refers to right-hand rotation when viewing downward from above in the up-down direction. “Counterclockwise” refers to left-hand rotation when viewing downward from above in the up-down direction. An open-and-closed direction is a direction with an open direction as a direction which is orthogonal to the front-rear direction and in which the first and second contact-move-members move away from each other, and a closed direction as a direction which is orthogonal to the front-rear direction and in which the first and second contact-move-members approach each other.

As shown in FIG. 1, the end effector 1 is a device for cutting off, for example, a stem G (see FIG. 4) from a branch and harvesting grapes. In this embodiment, the end effector 1 performs processing for cutting a processing portion Ta (see FIG. 6A) in the stem G as a target object by the processing mechanism 10 (see FIG. 2A). The end effector 1 includes the body member 2, an electric cylinder 3 as an actuator, the target-object-positioning mechanism 4 (see FIG. 2A) and the processing mechanism 10.

The body member 2 is a component constituting a frame of the end effector 1. The body member 2 is a substantially rectangular parallelepiped casing with an opening. The body member 2 is sized to allow the target-object-positioning mechanism 4 and the processing mechanism 10 to be accommodated therein. The electric cylinder 3, the target-object-positioning mechanism 4 and the processing mechanism 10 are accommodated inside the body member 2. A cover 2a is attached to the opening area of the body member 2.

As shown in FIGS. 1, 2A and 2B, the electric cylinder 3 is an actuator for moving a piston rod 3a in an axial direction by an electric motor 3b (see FIG. 1). A moving direction of the piston rod 3a changes in accordance with a rotation direction of the electric motor 3b.

The electric cylinder 3 is fixed to a rear surface of the body member 2. The piston rod 3a of the electric cylinder 3 is inserted into a rod insertion hole 2b located at a rear portion of the body member 2. The piston rod 3a of the electric cylinder 3 is configured to be movable in the forward direction and in the rearward direction inside the body member 2. The electric motor 3b of the electric cylinder 3 is configured to be fixable to a work machine that moves the end effector 1. The body member 2 is configured to be supported by the work machine via the electric cylinder 3.

<Target-Object-Positioning Mechanism 4>

As shown in FIGS. 2A and 2B, the target-object-positioning mechanism 4 is a mechanism for positioning the stem G that is a target object. The target-object-positioning mechanism 4 includes a coupling member 5, the contact-move-member-moving mechanism 6, the opening-closing member 7, an opening-closing-member-moving mechanism 8 and a guide member for opening and closing (opening-closing-guide member) 9.

The coupling member 5 is a member for coupling the contact-move-member-moving mechanism 6 and the opening-closing-member-moving mechanism 8. A rear end portion of the coupling member 5 is coupled to an intermediate shaft for opening and closing (opening-closing-intermediate shaft) 8h of the opening-closing-member-moving mechanism 8. The coupling member 5 is configured to be movable in the forward direction and in the rearward direction. A front end portion of the coupling member 5 is located inside the opening-closing member 7. The front end portion of the coupling member 5 includes a moving-member-support shaft 5a for rotatably supporting a first contact-move member 6L and a second contact-move member 6R that are contact-move members. The moving-member-support shaft 5a extends in the upward direction.

As shown in FIGS. 2A, 2B and 3, the contact-move-member-moving mechanism 6 is a mechanism for grabbing the stem G that is a target object (see FIG. 4). The contact-move-member-moving mechanism 6 includes the first contact-move member 6L and the second contact-move member 6R. The first contact-move member 6L and the second contact-move member 6R are rectangular plate-like members that are curved. The first contact-move member 6L and the second contact-move member 6R are formed of rigid members free of elastic deformation like a spring upon receipt of an external force. The first contact-move member 6L and the second contact-move member 6R are provided at the body member 2.

The first contact-move member 6L is a member approaching the stem G from the left of the stem G. The first contact-move member 6L includes a first shaft-receiving portion 6La, a first extending portion 6Lb, a first guiding portion 6Lc and a first claw portion 6Ld. The first shaft-receiving portion 6La, the first extending portion 6Lb, the first guiding portion 6Lc and the first claw portion 6Ld are coupled together in this order to form the first contact-move members 6L. The first contact-move member 6L is formed as a single component.

The first shaft-receiving portion 6La is a cylindrical member. The first shaft-receiving portion 6La constitutes a first support portion supported by the body member 2. The first shaft-receiving portion 6La is rotatably inserted over the moving-member-support shaft 5a. The first shaft-receiving portion 6La is located at a proximal end portion of the first contact-move member 6L.

The first extending portion 6Lb is a rectangular plate member. One end portion of the first extending portion 6Lb is coupled to the outer circumferential surface of the first shaft-receiving portion 6La. When an extension direction of the first extending portion 6Lb is aligned with the forward direction, a rear end portion, i.e., the one end portion, of the first extending portion 6Lb is, when viewed in an axial direction of the first shaft-receiving portion 6La, located further rightward than the axis of the first shaft-receiving portion 6La on the outer circumferential surface of the first shaft-receiving portion 6La. The first extending portion 6Lb extends in a direction orthogonal to the axis of the first shaft-receiving portion 6La with its short sides aligned with the axis of the first shaft-receiving portion 6La. The first extending portion 6Lb is configured as a first proximal-end portion extending from the first shaft-receiving portion 6La supported by the body member 2.

The first guiding portion 6Lc is a rectangular plate member. One end portion of the first guiding portion 6Lc is coupled to the other end portion of the first extending portion 6Lb with its short sides aligned with the axial direction of the first shaft-receiving portion 6La. The first guiding portion 6Lc is included in a first distal-end portion extending from a front end portion, i.e., the other end portion, of the first extending portion 6Lb that is the first proximal-end portion. When the extension direction of the first extending portion 6Lb is aligned with the forward direction, the first guiding portion 6Lc is curved so as to have its apex further leftward than the front end portion, i.e., the other end portion, of the first extending portion 6Lb. The first guiding portion 6Lc includes a first rib portion 6Le (see FIG. 3). The first rib portion 6Le is located on an upper end surface of a front end portion of the first guiding portion 6Lc. The rigidity of the front end portion of the first guiding portion 6Lc is enhanced by the first rib portion 6Le.

The first claw portion 6Ld is a rectangular plate member. One end portion of the first claw portion 6Ld is coupled to the front end portion, i.e., the other end portion, of the first guiding portion 6Lc with its short sides aligned with the axial direction of the first shaft-receiving portion 6La. The first claw portion 6Ld is included in the first distal-end portion. When the extension direction of the first extending portion 6Lb is aligned with the forward direction, the first claw portion 6Ld is a hook portion extending from the front end portion of the first guiding portion 6Lc toward the right when viewed in the axial direction of the first shaft-receiving portion 6La. The first claw portion 6Ld is located at a front end portion of the first contact-move member 6L. The first claw portion 6Ld is bent at an angle of about 90 degrees to the first guiding portion 6Lc.

The first contact-move member 6L is supported by the body member 2 at the first support portion thereof via the moving-member-support shaft 5a. The first contact-move member 6L is rotatable with respect to the body member 2, with an axis of the moving-member-support shaft 5a as a first axis Ax1 that is a rotation center of the first contact-move member 6L (see FIGS. 2A and 3). The rear end portion of the first extending portion 6Lb that is the first proximal-end portion extending from the first shaft-receiving portion 6La supported by the body member 2 is located further rightward than a reference line D in a state where the first extending portion 6Lb extends in the forward direction along the reference line D that passes through the first axis Ax1 and extends in the front-rear direction.

The second contact-move member 6R is a member approaching the stem G from the right of the stem G. The second contact-move member 6R includes a second shaft-receiving portion 6Ra, a second extending portion 6Rb, a second guiding portion 6Rc and a second claw portion 6Rd. The second shaft-receiving portion 6Ra, the second extending portion 6Rb, the second guiding portion 6Rc and the second claw portion 6Rd are coupled together in this order to form the second contact-move members 6R. The second contact-move member 6R is formed as a single component.

The second shaft-receiving portion 6Ra is a cylindrical member. The second shaft-receiving portion 6Ra constitutes a second support portion supported by the body member 2. The second shaft-receiving portion 6Ra is rotatably inserted over the moving-member-support shaft 5a. The second shaft-receiving portion 6Ra is located at a proximal end portion of the second contact-move member 6R.

The second extending portion 6Rb is a rectangular plate member. One end portion of the second extending portion 6Rb is coupled to the outer circumferential surface of the second shaft-receiving portion 6Ra. When an extension direction of the second extending portion 6Rb is aligned with the forward direction, a rear end portion, i.e., the one end portion, of the second extending portion 6Rb is, when viewed in an axial direction of the second shaft-receiving portion 6Ra, located further leftward than the axis of the second shaft-receiving portion 6Ra on the outer circumferential surface of the second shaft-receiving portion 6Ra. The second extending portion 6Rb extends in a direction orthogonal to the axis of the second shaft-receiving portion 6Ra with its short sides aligned with the axis of the second shaft-receiving portion 6Ra. The second extending portion 6Rb is configured as a second proximal-end portion extending from the second shaft-receiving portion 6Ra supported by the body member 2.

The second guiding portion 6Rc is a rectangular plate member. One end portion of the second guiding portion 6Rc is coupled to the other end portion of the second extending portion 6Rb with its short sides aligned with the axial direction of the second shaft-receiving portion 6Ra. That is, the second guiding portion 6Rc is included in a second distal-end portion extending from a front end portion, i.e., the other end portion, of the second extending portion 6Rb that is the second proximal-end portion. When the extension direction of the second extending portion 6Rb is aligned with the forward direction, the second guiding portion 6Rc is curved so as to have its apex further rightward than the front end portion, i.e., the other end portion, of the second extending portion 6Rb. The second guiding portion 6Rc includes a second rib portion 6Re (see FIG. 3). The second rib portion 6Re is located on a lower end surface of a front end portion of the second guiding portion 6Rc. The rigidity of the front end portion of the second guiding portion 6Rc is enhanced by the second rib portion 6Re.

The second claw portion 6Rd is a rectangular plate member. One end portion of the second claw portion 6Rd is coupled to the front end portion, i.e., the other end portion, of the second guiding portion 6Rc with its short sides aligned with the axial direction of the second shaft-receiving portion 6Ra. The second claw portion 6Rd is included in the second distal-end portion. When the extension direction of the second extending portion 6Rb is aligned with the forward direction, the second claw portion 6Rd is a hook portion extending from the front end portion of the second guiding portion 6Rc toward the left when viewed in the up-down direction. The second claw portion 6Rd is located at a front end portion of the second contact-move member 6R. The second claw portion 6Rd is bent at an angle of about 90 degrees to the second guiding portion 6Rc. A width of the second claw portion 6Rd in the up-down direction is larger than a width of the first claw portion 6Ld in the up-down direction. The second claw portion 6Rd projects further upward than an upper end surface of the second guiding portion 6Rc.

The second contact-move member 6R is supported by the body member 2 at the second support portion thereof via the moving-member-support shaft 5a. The second contact-move member 6R is rotatable with respect to the body member 2, with the axis of the moving-member-support shaft 5a as a second axis Ax2 that is a rotation center of the second contact-move member 6R (see FIGS. 2A and 3). The rear end portion of the second extending portion 6Rb that is the second proximal-end portion extending from the second shaft-receiving portion 6Ra supported by the body member 2 is located further leftward than the reference line D in a state where the second extending portion 6Rb extends in the forward direction along the reference line D that passes through the second axis Ax2 and extends in the front-rear direction.

The second shaft-receiving portion 6Ra is rotatably supported by the moving-member-support shaft 5a at a position where the second shaft-receiving portion 6Ra is overlapped over the first shaft-receiving portion 6La supported by the moving-member-support shaft 5a. In this embodiment, the first axis Ax1 and the second axis Ax2 are the same axis.

The first shaft-receiving portion 6La and the second shaft-receiving portion 6Ra include a torsion spring 14 that is an elastic member generating a rotational force around the first axis Ax1. The torsion spring applies a counterclockwise rotational force to the first shaft-receiving portion 6La and a clockwise rotational force to the second shaft-receiving portion 6Ra when viewed in the direction of the first axis Ax1. That is, the torsion spring applies rotational forces to the first contact-move member 6L and the second contact-move member 6R in a direction in which the first claw portion 6Ld and the second claw portion 6Rd move away from each other.

As shown in FIGS. 2A and 2B, the first contact-move member 6L and the second contact-move member 6R that are supported by the moving member support shaft 5a are configured to be movable in the forward direction and in the rearward direction along with movement in the forward direction and in the rearward direction of the opening-closing-member-moving mechanism 8. The coupling member 5, the first contact-move member 6L and the second contact-move member 6R are configured to be movable in the forward direction and in the rearward direction between the grabbing position P1 that is the farthest from a front end portion of the body member 2 and the processing position P2 (see FIG. 5) that is the closest to the front end portion of the body member 2, within a movable range in the forward direction or in the rearward direction of the coupling member 5 and the first and second contact-move members 6L, 6R moved by the opening-closing-member-moving mechanism 8.

The opening-closing member 7 is a member for changing state of the first contact-move member 6L and the second contact-move member 6R between a closed state in which they are located close to each other and an open state in which they are located apart from each other. The opening-closing member 7 is a tubular member that is opened at both ends. In this embodiment, the opening-closing member 7 is a tubular member with rectangular-shaped openings. The opening-closing member 7 is located in an opening-closing-member-insertion hole 2c at a front portion of the body member 2. The opening-closing member 7 is supported to be movable in the forward direction and in the rearward direction. The opening-closing member 7 is so disposed that its flat side surfaces are located in the up-down direction and in the left-right direction.

Inside the opening-closing member 7, the front end portion of the coupling member 5, the first contact-move member 6L and the second contact-move member 6R are located to be movable in the forward direction and in the rearward direction. A rear end portion of the opening-closing member 7 is engaged with an opening-closing-member-coupling portion 7a via a buffer member 7b.

The opening-closing-member-coupling portion 7a restricts forward movement of the opening-closing member 7 with respect to the opening-closing-member-coupling portion 7a. The opening-closing-member-coupling portion 7a permits rearward movement of the opening-closing member 7 with respect to the opening-closing-member-coupling portion 7a by contraction of the buffer member 7b. A rear end portion of the opening-closing-member-coupling portion 7a is connected to the opening-closing-member-moving mechanism 8. A front end portion of the opening-closing member 7 is movable from the rear position P3 that is the closest to the front end portion of the body member 2, to the front position P4 (see FIG. 4) that is the furthest forward position where a front end portion of the opening-closing-member-coupling portion 7a makes contact with the front end position of the body member 2, within a movable range in the front-rear direction of the opening-closing member 7 moved by the opening-closing-member-moving mechanism 8.

A part of the first contact-move member 6L is located inside the opening-closing member 7 with the first claw portion 6Ld located further forward than the first shaft-receiving portion 6La. A part of the second contact-move member 6R is located inside the opening-closing member 7 with the second claw portion 6Rd located further forward than the second shaft-receiving portion 6Ra. The first contact-move member 6L and the second contact-move member 6R extend from the opening-closing-member-insertion hole 2c to the outside of the body member 2 through the interior of the opening-closing member 7.

The first extending portion 6Lb or the first guiding portion 6Lc makes contact with a first contacted portion 7c that is a left front-end portion of the inner circumferential surface of the opening-closing member 7, by an elastic restoring force of the torsion spring. The second extending portion 6Rb or the second guiding portion 6Rc makes contact with a second contacted portion 7d that is a right front-end portion on the inner circumferential surface of the opening-closing member 7 and faces the first contacted portion 7c, by the elastic restoring force of the torsion spring.

The rear end portion of the first extending portion 6Lb coupled to the first shaft-receiving portion 6La is located further rightward than the reference line D. The first extending portion 6Lb or the first guiding portion 6Lc in contact with the first contacted portion 7c is located further leftward than the reference line D.

The rear end portion of the second extending portion 6Rb coupled to the second shaft-receiving portion 6Ra is located further leftward than the reference line D. The second extending portion 6Rb or the second guiding portion 6Rc in contact with the second contacted portion 7d is located further rightward than the reference line D.

The first contact-move member 6L and the second contact-move member 6R intersect each other inside the opening-closing member 7 when viewed in the up-down direction. An intersection portion Cx where the first contact-move member 6L and the second contact-move member 6R intersect each other is located further forward than the first shaft-receiving portion 6La and the second shaft-receiving portion 6Ra into which the moving-member-support shaft 5a is inserted, and further rearward than the first contacted portion 7c and the second contacted portion 7d.

The intersection portion Cx is located on the reference line D when viewed in the up-down direction. The portion forward of the intersection portion Cx in the first contact-move member 6L is located further leftward than the reference line D. The portion rearward of the intersection portion Cx in the first contact-move member 6L is located further rightward than the reference line D. The portion forward of the intersection portion Cx in the second contact-move member 6R is located further rightward than the reference line D. The portion rearward of the intersection portion Cx in the second contact-move member 6R is located further leftward than the reference line D.

The first guiding portion 6Lc located further leftward than the reference line D is curved so that its apex is located on the left. That is, the first guiding portion 6Lc is curved toward the left in a direction away from the second contact-move member 6R that is located further rightward than the reference line D. The first claw portion 6Ld extends toward the second contact-move member 6R.

The second guiding portion 6Rc located further rightward than the reference line D is curved so that its apex is located on the right. That is, the second guiding portion 6Rc is curved toward the right in a direction away from the first contact-move member 6L that is located further leftward than the reference line D. The second claw portion 6Rd extends toward the first contact-move member 6L.

In the first contact-move member 6L and the second contact-move member 6R disposed in this manner, an interval in the left-right direction between the first contacted portion 7c and the rear end portion of the first extending portion 6Lb as well as an interval in the left-right direction between the second contacted portion 7d and the rear end portion of the second extending portion 6Rb increase in proportion to an interval between the rear end portion of the first extending portion 6Lb and the rear end portion of the second extending portion 6Rb.

The inclination of each of the first contact-move member 6L and the second contact-move member 6R to the front-rear direction increases in proportion to the interval in the left-right direction between the first contacted portion 7c and the rear end portion of the first extending portion 6Lb, and the interval in the left-right direction between the second contacted portion 7d and the rear end portion of the second extending portion 6Rb.

Therefore, an interval between the first claw portion 6Ld and the second claw portion 6Rd of the end effector 1, in which the first contact-move member 6L and the second contact-move member 6R intersect each other in the opening-closing member 7, is larger than an interval between the first claw portion 6Ld and the second claw 6Rd of the end effector 1 having the first and second contact-move members 6L, 6R without intersecting each other in the opening-closing member 7.

As shown in FIG. 3, the first shaft-receiving portion 6La is overlapped by the first extending portion 6Lb extending from the left toward the right of the reference line D inside the opening-closing member 7 when viewed in the rearward direction. The second shaft-receiving portion 6Ra is overlapped by the second extending portion 6Rb extending from the right toward the left of the reference line D inside the opening-closing member 7 when viewed in the rearward direction. The first extending portion 6Lb and the second extension 6Rb thus function as a cover to prevent a foreign object that enters through the opening of the opening-closing member 7 from entering the first shaft-receiving portion 6La and the second shaft-receiving portion 6Ra.

As shown in FIGS. 2A and 2B, the opening-closing-member-moving mechanism 8 is an extendable link mechanism for moving the opening-closing member 7 in the forward direction and in the rearward direction. The opening-closing-member-moving mechanism 8 includes an input shaft for opening and closing (opening-closing-input shaft) 8a, a first input link for opening and closing (opening-closing-first-input link) 8b, a second input link for opening and closing (opening-closing-second-input link) 8c, a first intermediate link for opening and closing (opening-closing-first-intermediate link) 8f, a second intermediate link for opening and closing (opening-closing-second-intermediate link) 8g, the opening-closing-intermediate shaft 8h, a first output link for opening and closing (opening-closing-first-output link) 8i, a second output link for opening and closing (opening-closing-second-output link) 8j and an output shaft for opening and closing (opening-closing-output shaft) 8n. The opening-closing-member-moving mechanism 8 is supported by the coupling member 5 with an extending-contracting direction thereof aligned with the front-rear direction.

In the opening-closing-member-moving mechanism 8, the opening-closing-input shaft 8a, the opening-closing-first-input link 8b and the opening-closing-second-input link 8c, the opening-closing-first-intermediate link 8f and the opening-closing-second-intermediate link 8g, the opening-closing-first-output link 8i and the opening-closing-second-output link 8j, and the opening-closing-output shaft 8n, are coupled in this order from a rear end portion toward a front end portion of the opening-closing-member-moving mechanism 8. The opening-closing-input shaft 8a located at the rear end portion of the opening-closing-member-moving mechanism 8 is coupled to the piston rod 3a of the electric cylinder 3. The opening-closing-intermediate shaft 8h located at a center portion in the front-rear direction of the opening-closing-member-moving mechanism 8 is fixed to the coupling member 5. The opening-closing-output shaft 8n located at the front end portion of the opening-closing-member-moving mechanism 8 is coupled to the opening-closing-member-coupling portion 7a.

The opening-closing-first-input link 8b and the opening-closing-second-input link 8c are links to which a driving force is input from the electric cylinder 3. A rear end portion of the opening-closing-first-input link 8b and a rear end portion of the opening-closing-second-input link 8c are rotatably coupled to the opening-closing-input shaft 8a.

A front end portion of the opening-closing-first-input link 8b is rotatably coupled to a rear end portion of the opening-closing-first-intermediate link 8f. A front end portion of the opening-closing-second-input link 8c is rotatably coupled to a rear end portion of the opening-closing-second-intermediate link 8g.

The opening-closing-first-intermediate-link 8f and the opening-closing-second-intermediate-link 8g intersect each other at their respective midpoint positions. The opening-closing-first-intermediate link 8f and the opening-closing-second-intermediate link 8g are rotatably coupled, at their intersection positions, to the opening-closing-intermediate shaft 8h fixed to the coupling member 5.

The opening-closing-first-output link 8i and the opening-closing-second-output link 8j are links for outputting a driving force. A rear end portion of the opening-closing-first-output link 8i is rotatably coupled to a front end portion of the opening-closing-first-intermediate link 8f. A rear end portion of the opening-closing-second-output link 8j is rotatably coupled to a front end portion of the opening-closing-second-intermediate link 8g. A front end portion of the opening-closing-first-output link 8i and a front end portion of the opening-closing-second-output link 8j are rotatably coupled to the opening-closing member 7 by the opening-closing-output shaft 8n.

As shown in FIG. 4, when the opening-closing-input shaft 8a is moved in the rearward direction (see arrow X) in the opening-closing-member-moving mechanism 8 by the electric cylinder 3, a distance in the front-rear direction between the opening-closing-input shaft 8a and the opening-closing-intermediate shaft 8h increases, and also a distance in the front-rear direction between the opening-closing-intermediate shaft 8h and the opening-closing-output shaft 8n increases.

The opening-closing-member-moving mechanism 8 moves the opening-closing member 7 in the forward direction via the opening-closing-member-coupling portion 7a to which the opening-closing-output shaft 8n is coupled. When the opening-closing-input shaft 8a is moved in the forward direction, the opening-closing-member-moving mechanism 8 moves the opening-closing member 7, to which the opening-closing-output shaft 8n is coupled via the opening-closing-member-coupling portion 7a, in the rearward direction.

The opening-closing-guide member 9 is a member for guiding the opening-closing-member-moving mechanism 8 in the forward direction and in the rearward direction. The opening-closing-guide member 9 is a grooved cam. The opening-closing-guide member 9 is located at the left and at the right of the opening-closing-member-moving mechanism 8 when viewed in the up-down direction.

The opening-closing-guide member 9 located at the left of the opening-closing-member-moving mechanism 8 is contacted by the rear end portion of the opening-closing-first-intermediate link 8f and the front end portion of the opening-closing-second-intermediate link 8g that move in the forward direction and in the rearward direction through extension and contraction of the opening-closing-member-moving mechanism 8. The opening-closing-guide member 9 located at the right of the opening-closing-member-moving mechanism 8 is contacted by the front end portion of the opening-closing-first-intermediate link 8f and the rear end portion of the opening-closing-second-intermediate link 8g that move in the forward direction and in the rearward direction through extension and contraction of the opening-closing-member-moving mechanism 8. Therefore, the position in the front-rear direction and in the left-right direction of the opening-closing-intermediate shaft 8h with respect to the body member 2 is held in an extension and contraction range of the opening-closing-member-moving mechanism 8 by the opening-closing-guide members 9.

As shown in FIG. 5, when the opening-closing-input shaft 8a is moved in the rearward direction beyond the extension and contraction range of the opening-closing-member-moving mechanism 8 (see arrow X), the both end portions of the opening-closing-first-intermediate link 8f and the both end portions of the opening-closing-second-intermediate link 8g move away from the opening-closing-guide members 9. This causes the opening-closing-intermediate axis 8h to be movable in the rearward direction with respect to the body member 2. When the opening-closing-input shaft 8a is moved in the rearward direction beyond the extension and contraction range of the opening-closing-member-moving mechanism 8, the opening-closing-member-moving mechanism 8 moves the opening-closing member 7, to which the opening-closing-output shaft 8n is coupled via the opening-closing-member-coupling portion 7a, in the rearward direction (see arrow Y).

<Processing Mechanism 10>

As shown in FIGS. 6A and 6B, the processing mechanism 10 is a mechanism for performing processing for cutting the stem G at the processing portion Ta (see FIG. 6A). The processing mechanism 10 includes the processing blade 11 and a processing-blade-moving mechanism 12.

The processing blade 11 cuts the stem G. The processing blade 11 is located above the opening-closing member 7 in the opening-closing-member-insertion hole 2c with its cutting edge facing forward. The processing blade 11 is supported by the opening-closing member 7 so as to be movable in the forward direction and in the rearward direction along an upper surface of the opening-closing member 7. A rear end portion of the processing blade 11 is coupled to the processing-blade-moving mechanism 12.

The processing-blade-moving mechanism 12 is an extendable link mechanism for moving the processing blade 11 in the forward direction and in the rearward direction. The processing-blade-moving mechanism 12 includes an input shaft for processing (processing input shaft) 12a, a first input link for processing (processing-first-input link) 12b, a second input link for processing (processing-second-input link) 12c, a first intermediate link for processing (processing-first-intermediate link) 12f, a second intermediate link for processing (processing-second-intermediate link) 12g, an intermediate shaft for processing (processing intermediate shaft) 12h, a first output link for processing (processing-first-output link) 12i, a second output link for processing (processing-second-output link) 12j and an output shaft for processing (processing output shaft) 12n. The processing-blade-moving mechanism 12 is located above the opening-closing-member-moving mechanism 8 with an extending-contracting direction thereof aligned with the front-rear direction.

In the processing-blade-moving mechanism 12, the processing input shaft 12a, the processing-first-input link 12b and the processing-second-input link 12c, the processing-first-intermediate link 12f and the processing-second-intermediate link 12g, the processing-first-output link 12i and the processing-second-output link 12j, and the processing output shaft 12n are coupled in this order from a rear end portion toward a front end portion of the processing-blade-moving mechanism 12.

The processing intermediate shaft 12h of the processing-blade-moving mechanism 12 is supported by a guide member for processing (processing guide member) 13 fixed to the body member 2. This allows the processing-blade-moving mechanism 12 to hold its position in the front-rear direction and in the left-right direction with respect to the body member 2. The processing input shaft 12a located at the rear end portion of the processing-blade-moving mechanism 12 is coupled to the opening-closing-intermediate shaft 8h of the opening-closing-member-moving mechanism 8. The processing output shaft 12n located at the front end portion of the processing-blade-moving mechanism 12 is coupled to the processing blade 11.

The processing-first-input link 12b and the processing-second-input link 12c are links into which a driving force is input. A rear end portion of the processing-first-input link 12b and a rear end portion of the processing-second-input link 12c are rotatably coupled to the processing input shaft 12a.

A rear end portion of the processing-first-intermediate link 12f is rotatably coupled to a front end portion of the processing-first-input link 12b. A rear end portion of the processing-second-intermediate link 12g is rotatably coupled to a front end portion of the processing-second-input link 12c.

The processing-first-intermediate link 12f and the processing-second-intermediate link 12g intersect each other at their respective midpoint positions. The processing-first-intermediate link 12f and the processing-second-intermediate link 12g are rotatably coupled, at their intersection positions, to the processing intermediate shaft 12h.

The processing-first-output link 12i and the processing-second-output link 12j are links for outputting driving forces input from the processing-first-intermediate link 12f and the processing-second-intermediate link 12g. A rear end portion of the processing-first-output link 12i is rotatably coupled to a front end portion of the processing-first-intermediate link 12f. A rear end portion of the processing-second-output link 12j is rotatably coupled to a front end portion of the processing-second-intermediate link 12g. A front end portion of the processing-first-output link 12i and a front end portion of the processing-second-output link 12j are coupled to the processing output shaft 12n.

As shown in FIGS. 7A and 7B, when the processing input shaft 12a is moved in the rearward direction (see arrow X) in the processing-blade-moving mechanism 12, a distance in the front-rear direction between the processing input shaft 12a and the processing intermediate shaft 12h increases, and also a distance in the front-rear direction between the processing output shaft 12n and the processing intermediate shaft 12h increases.

The processing input shaft 12a is moved in the rearward direction as the opening-closing-intermediate shaft 8h of the opening-closing-member-moving mechanism 8 moves in the rearward direction. The processing-blade-moving mechanism 12 thereby moves the processing blade 11, to which the processing output shaft 12n is coupled, in the forward direction. The processing-blade-moving mechanism 12 also moves the processing blade 11 in the rearward direction as the opening-closing-intermediate shaft 8h of the opening-closing-member-moving mechanism 8 moves in the forward direction.

The end effector 1 thus configured has a configuration in which the target-object-positioning mechanism 4 and the processing mechanism 10 are interlocked via the opening-closing-intermediate shaft 8h. The end effector 1 is configured such that the target-object-positioning mechanism 4 and the processing mechanism 10 are operable by the single electric cylinder 3. Therefore, the size, weight and moment of inertia of the end effector 1 are small, compared with a case where the end effector has separate actuators to operate the first contact-move member 6L and the second contact-move member 6R, respectively. This allows the end effector 1 to suppress interference with objects around a target object, while reducing the time required to move the end effector 1 and the energy required to move the end effector 1, without highly precisely moving the work machine that moves the end effector 1.

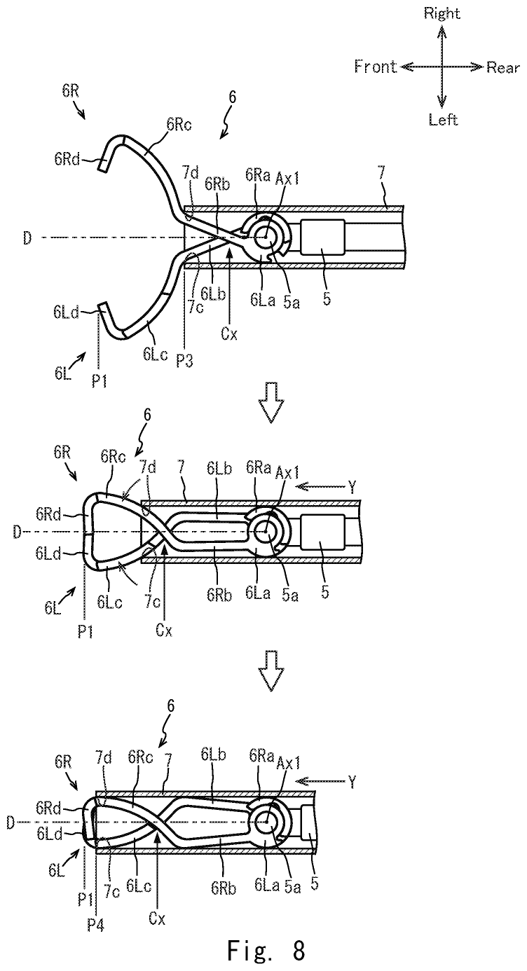

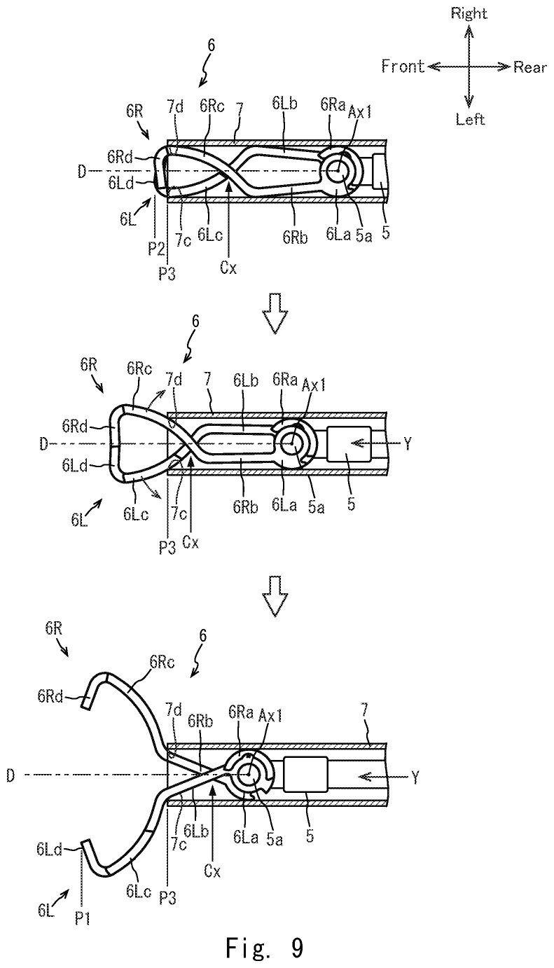

Opening and closing of the first contact-move member 6L and the second contact-move member 6R by the opening-closing member 7 will now be described with reference to FIGS. 2B, 4, 5, 8 and 9. FIG. 8 is partial cross-sectional views showing when the opening-closing member 7 moves from the rear position P3 to the front position P4 with the contact-move-member-moving mechanism 6 at the grabbing position P1. FIG. 9 is partial cross-sectional views showing when the contact-move-member-moving mechanism 6 moves from the processing position P2 to the grabbing position P1 with the opening-closing member 7 at the rear position P3.

As shown in FIG. 2B and the upper diagram of FIG. 8, when the first contact-move member 6L and the second contact-move member 6R are located at the grabbing position P1 and the opening-closing member 7 is located at the rear position P3, the first guiding portion 6Lc and the second guiding portion 6Rc are located further forward than the front end portion of the opening-closing member 7. That is, the first guiding portion 6Lc and the second guide 6Rc are located outside the opening-closing member 7. In this state, the first guiding portion 6Lc is located further leftward than the first contacted portion 7c of the opening-closing member 7. The second guiding portion 6Rc is located further rightward than the second contacted portion 7d of the opening-closing member 7.

As shown in the middle diagram of FIG. 8, when the first contact-move member 6L is located at the grabbing position P1 and the opening-closing member 7 moves from the rear position P3 to the front position P4 (see arrow Y), the first contacted portion 7c, while maintaining contact with the first guiding portion 6Lc located at the left of the reference line D, moves along the first guiding portion 6Lc from its rear end portion toward its front end portion. The forward movement of the opening-closing member 7 causes the first contacted portion 7c to apply a forward force to the first guiding portion 6Lc. The first contact-move member 6L is rotated by the force applied from the first contacted portion 7c in a direction approaching the second contact-move member 6R (the direction approaching the reference line D) with the first axis Ax1 as the rotation center. That is, the first contact-move member 6L moves in the right direction that is an open direction and closed direction orthogonal to the front-rear direction. The first contact-move member 6L increasingly approaches the second contact-move member 6R as a contact position of the first contacted portion 7c on the first guiding portion 6Lc shifts from the rear end portion toward the front end portion of the first guiding portion 6Lc.

Similarly, the second contacted portion 7d, while maintaining contact with the second guiding portion 6Rc located at the right of the reference line D, moves along the second guiding portion 6Rc from its rear end portion toward its front end portion. The forward movement of the opening-closing member 7 causes the second contacted portion 7d to apply a forward force to the second guiding portion 6Rc. The second contact-move member 6R is rotated by the force applied from the second contacted portion 7d in a direction approaching the first contact-move member 6L (the direction approaching the reference line D) with the second axis Ax2 as the rotation center. That is, the second contact-move member 6R moves in the left direction that is the open direction and closed direction orthogonal to the front-rear direction. The second contact-move member 6R increasingly approaches the first contact-move member 6L as a contact position of the second contacted portion 7d on the second guiding portion 6Rc shifts from the rear end portion toward the front end portion of the second guiding portion 6Rc.

The intersection portion Cx between the first contact-move member 6L and the second contact-move member 6R shifts in the forward direction with respect to the first contact-move member 6L and the second contact-move member 6R as the opening-closing member 7 moves from the rear position P3 to the front position P4. In each of the first contact-move member 6L and the second contact-move member 6R, the proportion of a portion rearward of the intersection portion Cx to the entirety increases as the intersection portion Cx shifts in the forward direction with respect to the first contact-move member 6L and the second contact-move member 6R.

That is, the proportion of a portion located further rightward than the reference line D in the first contact-move member 6L to its entirety, and the proportion of a portion located further leftward than the reference line D in the second contact-move member 6R to its entirety increase as the intersection portion Cx shifts in the forward direction with respect to the first contact-move member 6L and the second contact-move member 6R. Thus, movement of the opening-closing member 7 from the rear position P3 to the front position P4 causes the first contact-move member 6L and the second contact-move member 6R located at the grabbing position P1 to change from the open state, in which they are located apart from each other, to the closed state, in which they are located close to each other.

As shown in FIG. 4 and the lower diagram of FIG. 8, in a state where the opening-closing member 7 is located at the front position P4, the first extending portion 6Lb that is the first proximal-end portion of the first contact-move member 6L is located at the right of the reference line D. The first extending portion 6Lb extends toward the right, away from the second contact-move member 6R. That is, the first extending portion 6Lb extends in a direction away from the first contacted portion 7c at the right of the reference line D.

The second extending portion 6Rb that is the second proximal-end portion of the second contact-move member 6R is located at the left of the reference line D. The second extending portion 6Rb extends toward the left, away from the first contact-move member 6L. That is, the second extending portion 6Rb extends in a direction away from the second contacted portion 7d at the left of the reference line D.

Therefore, a rotation angle of the first extending portion 6Lb located at the right of the reference line D until it makes contact with the first contacted portion 7c located at the left of the reference line D increases because the first extending portion 6Lb extends in the direction away from the first contacted portion 7c. A rotation angle of the second extending portion 6Rb located at the left of the reference line D until it makes contact with the second contacted portion 7d located at the right of the reference line D increases because the second extending portion 6Rb extends in the direction away from the second contacted portion 7d.

In a state where the opening-closing member 7 is located at the front position P4, the first guiding portion 6Lc included in the first distal-end portion of the first contact-move member 6L extends from the front end portion of the first extending portion 6Lb located at the right of the reference line D toward the left so as to approach the second contact-move member 6R, thereby intersecting the second contact-move member 6R. That is, the first guiding portion 6Lc extends from the right toward the left of the reference line D.

The second guiding portion 6Rc included in the second distal-end portion of the second contact-move member 6R extends from the front end portion of the second extending portion 6Rb located at the left of the reference line D toward the right so as to approach the first contact-move member 6L, thereby intersecting the first contact-move member 6L. That is, the second guiding portion 6Rc extends from the left toward the right of the reference line D.

Therefore, when the first guiding portion 6Lc is located at the left of the reference line D and the second guiding portion 6Rc is located at the right of the reference line D, an interval between the first claw portion 6Ld and the second claw portion 6Rd increases because the first guiding portion 6Lc extends from the first extending portion 6Lb toward the left and the second guiding portion 6Rc extends from the second extending portion 6Rb toward the right.

As shown in FIG. 4, the first claw portion 6Ld and the second claw portion 6Rd at the grabbing position P1 are located further forward than the front end portion of the opening-closing member 7 at the front position P4. The front end portion of the opening-closing member 7 is located apart from the first claw portion 6Ld and the second claw portion 6Rd. In this embodiment, there is a gap where the stem G can be placed between the front end portion of the opening-closing member 7 at the front position P4 and the first and second claw portions 6Ld, 6Rd at the grabbing position P1.

The first claw portion 6Ld and the second claw portion 6Rd at least partially overlap each other when viewed in the axial direction of the first axis Ax1. The projecting portion in the second claw portion 6Rd that projects further upward than the upper end surface of the second guiding portion 6Rc overlaps a front end surface of the opening-closing member 7 when viewed in the rearward direction. That is, a part of a rear side surface of the second claw portion 6Rd overlaps the front end surface of the opening-closing member 7 when viewed in the rearward direction. Thus, the first contact-move member 6L and the second contact-move member 6R that have grabbed the stem G can grasp the stem G from the forward direction and the rearward direction by the first and second claw portions 6Ld, 6Rd and the opening-closing member 7.

As shown in FIG. 5 and the upper diagram of FIG. 9, when the first contact-move member 6L and the second contact-move member 6R are located at the processing position P2 and the opening-closing member 7 is located at the rear position P3, the first guiding portion 6Lc and the second guiding portion 6Rc are located further rearward than the front end portion of the opening-closing member 7. That is, the first guiding portion 6Lc and the second guide 6Rc are located inside the opening-closing member 7. In this state, the first guiding portion 6Lc is located further rightward than the first contacted portion 7c of the opening-closing member 7. The second guiding portion 6Rc is located further leftward than the second contacted portion 7d of the opening-closing member 7.

As shown in the middle diagram of FIG. 9, when the opening-closing member 7 is located at the rear position P3 and the first contact-move member 6L moves from the processing position P2 to the grabbing position P1 (see arrow Y), the first contacted portion 7c, while maintaining contact with the first guiding portion 6Lc, moves along the first guiding portion 6Lc from its front end portion toward its rear end portion. The torsion spring of the first contact-move member 6L applies a counterclockwise rotational force by an elastic restoring force to the first contact-move member 6L with the first axis Ax1 as the rotation center. The first contact-move member 6L is rotated by the force applied from the torsion spring in the direction away from the second contact-move member 6R (the direction away from the reference line D) with the first axis Ax1 as the rotation center. That is, the first contact-move member 6L moves in the left direction, which is the open direction and closed direction orthogonal to the front-rear direction. The first contact-move member 6L moves away from the second contact-move member 6R as the contact position of the first contacted portion 7c on the first guiding portion 6Lc shifts from the front end portion toward the rear end portion of the first guiding portion 6Lc.

Similarly, when the opening-closing member 7 is located at the rear position P3 and the second contact-move member 6R moves from the processing position P2 to the grabbing position P1, the second contacted portion 7d, while maintaining contact with the second guiding portion 6Rc, moves along the second guiding portion 6Rc from its front end portion toward its rear end portion. The torsion spring of the second contact-move member 6R applies a clockwise rotational force by an elastic restoring force to the second contact-move member 6R with the second axis Ax2 as the rotation center. The second contact-move member 6R is rotated by the force applied from the torsion spring in the direction away from the first contact-move member 6L (the direction away from the reference line D) with the second axis Ax2 as the rotation center. That is, the second contact-move member 6R moves in the right direction that is the open direction and closed direction orthogonal to the front-rear direction. The second contact-move member 6R moves away from the first contact-move member 6L as the contact position of the second contacted portion 7d on the second guiding portion 6Rc shifts from the front end portion toward the rear end portion of the second guiding portion 6Rc.

As shown in FIG. 2B and the lower diagram of FIG. 9, the intersection portion Cx between the first contact-move member 6L and the second contact-move member 6R shifts in the rearward direction with respect to the first contact-move member 6L and the second contact-move member 6R as the first contact-move member 6L and the second contact-move member 6R move from the processing position P2 to the grabbing position P1. In each of the first contact-move member 6L and the second contact-move member 6R, the proportion of a portion forward of the intersection portion Cx to the entirety increases as the intersection portion Cx shifts in the rearward direction with respect to the first contact-move member 6L and the second contact-move member 6R.

That is, the proportion of a portion located further leftward than the reference line D in the first contact-move member 6L to its entirety, and the proportion of a portion located further rightward than the reference line D in the second contact-move member 6R to its entirety increase as the intersection portion Cx shifts in the rearward direction with respect to the first contact-move member 6L and the second contact-move member 6R. The first contact-move member 6L and the second contact-move member 6R located at the grabbing position P1 are thereby changed from the closed state, in which they are located close to each other, to the open state, in which they are located apart from each other.

The first claw portion 6Ld located at the grabbing position P1 is away from the reference line D toward the left in accordance with an amount of curvature of the first guiding portion 6Lc that is curved in the left direction. The second claw portion 6Rd located at the grabbing position P1 is away from the reference line D toward the right in accordance with an amount of curvature of the second guiding portion 6Rc that is curved in the right direction. Therefore, the interval between the first claw portion 6Ld and the second claw portion 6Rd is increased in the left-right direction, compared with a case of the first and second guiding portions 6Lc, 6Rc without being curved.

The first contact-move member 6L and the second contact-move member 6R thus configured function as the contact-move-member-moving mechanism 6 in which the first contact-move member 6L and the second contact-move member 6R are moved relative to each other in the left-right direction of the end effector 1 by the torsion springs and the opening-closing member 7. The contact-move-member-moving mechanism 6 makes contact with the stem G from the left direction and from the right direction by the first contact-move member 6L and the second contact-move member 6R. Therefore, the contact-move-member-moving mechanism 6 can grab the stem G located between the first claw portion 6Ld and the second claw 6Rd.

<Operation of Each Process>

Operation of the target-object-positioning mechanism 4 and the processing mechanism of the end effector 1 will now be described with reference to FIGS. 2A, 2B, 4, 5, 7A, 7B and 12.

The end effector 1 performs a grabbing process by the target-object-positioning mechanism 4, a positioning process by the target-object-positioning mechanism 4, a processing process by the processing mechanism 10, and a release process by the target-object-positioning mechanism 4. The first contact-move member 6L and the second contact-move member 6R are located at the grabbing position P1. The opening-closing member 7 is located at the rear position P3.

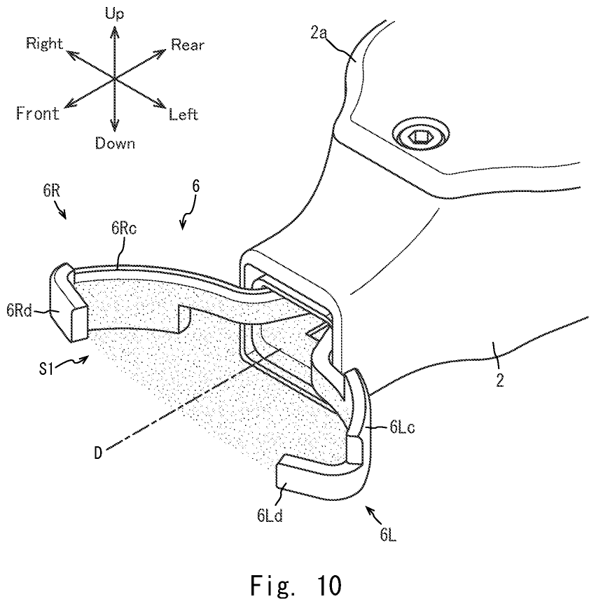

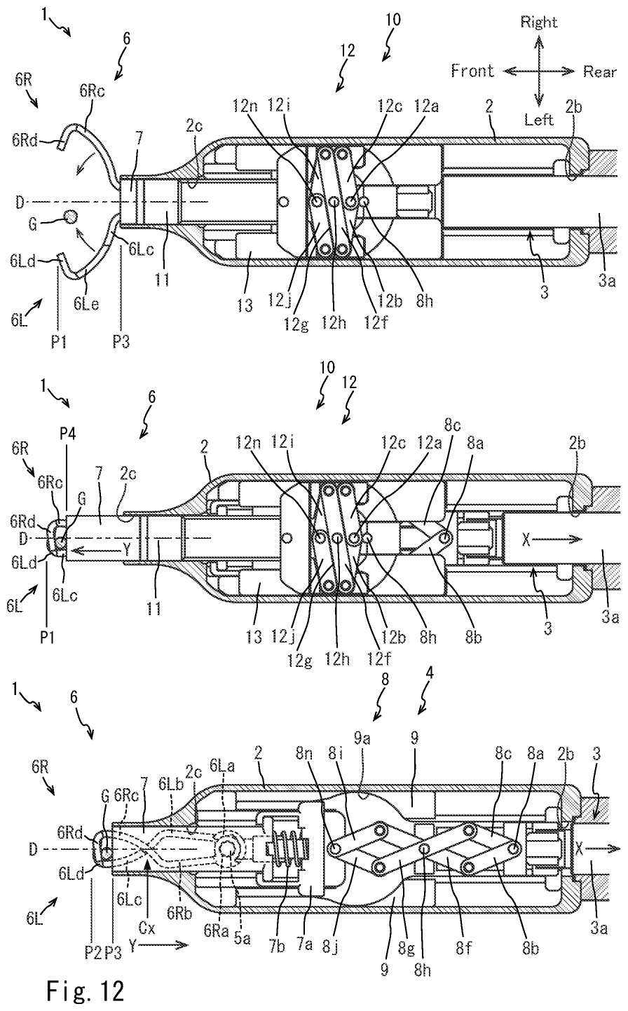

As shown in FIG. 12, in the grabbing process by the target-object-positioning mechanism 4, the end effector 1 is moved by the work machine so that the stem G is included in an area surrounded by the first contact-move member 6L and the second contact-move member 6R (see FIG. 10).

As shown in FIGS. 4 and 12, the end effector 1 moves the opening-closing-input shaft 8a of the opening-closing-member-moving mechanism 8 in the rearward direction by the electric cylinder 3 (see arrow X). The opening-closing-member-moving mechanism 8 thereby moves the opening-closing member 7 coupled to the opening-closing-output shaft 8n, from the rear position P3 to the front position P4 (see arrow Y).

With the movement of the opening-closing member 7 in the forward direction, the opening-closing member 7 causes the first claw portion 6Ld of the first contact-move member 6L and the second claw portion 6Rd of the second contact-move member 6R that are the contact-move-member-moving mechanisms 6 to move in the direction approaching the reference line D extending in the front-rear direction. That is, the opening-closing member 7 moves the first contact-move member 6L and the second contact-move member 6R in the open direction and the closed direction that are the left-right direction orthogonal to the reference line D. At this time, the first contact-move member 6L and the second contact-move member 6R remain unmoved in the front-rear direction with respect to the body member 2. The first contact-move member 6L and the second contact-move member 6R are changed into the closed state at the grabbing position P1.

The end effector 1 surrounds and grabs the stem G at the grabbing position P1 by the first contact-move member 6L and the second contact-move member 6R as well as the opening-closing member 7 that has moved to the front position P4. The first guiding portion 6Lc and the second guiding portion 6Rc restrict movement of the stem G in the left direction and in the right direction. The first claw portion 6Ld and the second claw portion 6Rd restrict movement of the stem G in the forward direction. The front end surface of the opening-closing member 7 restricts movement of the stem G in the rearward direction. The projecting portion of the second claw portion 6Rd and the front end surface of the opening-closing member 7 pinch the stem G from the forward direction and from the rearward direction, and hold an area near the processing portion Ta in the stem G. The first contact-move member 6L and the second contact-move member 6R may make contact with a portion including a part of the processing portion Ta of the stem G.

As shown in FIGS. 5 and 12, in the positioning process by the target-object-positioning mechanism 4, the end effector 1 moves the opening-closing-input shaft 8a further rearward by the electric cylinder 3 (see arrow X). The coupling member 5 supporting the opening-closing-intermediate shaft 8h moves in the rearward direction together with the opening-closing-input shaft 8a. The processing input shaft 12a coupled to the opening-closing-intermediate shaft 8h moves in the rearward direction together with the opening-closing-input shaft 8a.

The opening-closing member 7 is moved from the front position P4 to the rear position P3 by the opening-closing-member-moving mechanism 8. Simultaneously, the first contact-move member 6L and the second contact-move member 6R are moved from the grabbing position P1 to the processing position P2 along with movement of the coupling member 5 in the rearward direction. The stem G is thereby moved to the processing position P2 while being grabbed by the first contact-move member 6L, the second contact-move member 6R and the opening-closing member 7.

As shown in FIGS. 7A and 7B, in the processing process by the processing mechanism 10, simultaneously with the movement of the stem G, the end effector 1 moves the processing input shaft 12a of the processing-blade-moving mechanism 12 in the rearward direction by the electric cylinder 3 (see arrow X). The processing-blade-moving mechanism 12 thereby moves the processing blade 11 coupled to the processing output shaft 12n in the forward direction (see arrow Y). The end effector 1 brings the processing blade 11 moving in the forward direction into contact with the stem G that is moved in the rearward direction, to thereby cut the stem G at the processing portion Ta.

The end effector 1 holds the stem G from the forward direction and from the rearward direction by the front end surface of the opening-closing member 7 and the projecting portion of the second claw portion 6Rd of the second contact-move member 6R that are located near the processing blade 11. Therefore, the stem G is free of deformation in the forward direction by a force of the processing blade 11 when the processing blade 11 makes contact with the processing portion Ta. The end effector 1 can thereby improve a rate of cutting the stem G by the processing blade 11.

The opening-closing-member-moving mechanism 8 that is restricted from moving in the left direction and in the right direction by the opening-closing-guide members 9 while maintaining an amount of extension in the front-rear direction, is moved in the forward direction by the electric cylinder 3. At this time, the coupling member 5 supporting the opening-closing-intermediate shaft 8h moves together with the opening-closing-member-moving mechanism 8 in the forward direction. In addition, the processing input shaft 12a coupled to the opening-closing-intermediate shaft 8h moves in the forward direction together with the coupling member 5.

The opening-closing member 7 is moved from the rear position P3 to the front position P4 through movement of the opening-closing-member-moving mechanism 8 in the forward direction. The first contact-move member 6L and the second contact-move member 6R are also moved from the processing position P2 to the grabbing position P1 through movement of the coupling member 5 in the forward direction. The first contact-move member 6L, the second contact-move member 6R and the opening-closing member 7 are thereby moved in the forward direction with the cut grapes grabbed by them. Simultaneously, the processing blade 11 is accommodated in the opening-closing-member-insertion hole 2c of the body member 2 through movement of the processing input shaft 12a in the forward direction.

In the release process by the target-object-positioning mechanism 4, the opening-closing-member-moving mechanism 8 is moved further forward by the electric cylinder 3 while being guided by the opening-closing-guide members 9. This causes contraction of the opening-closing-member-moving mechanism 8 in the front-rear direction while the position of the opening-closing-intermediate shaft 8h in the front-rear direction with respect to the body member 2 is held. The coupling member 5 supporting the opening-closing-intermediate shaft 8h remains unmoved in the forward direction and in the rearward direction. In addition, the processing input shaft 12a of the processing-blade-moving mechanism 12 remains unmoved in the forward direction and in the rearward direction together with the coupling member 5.

As shown in FIGS. 2A, 2B and 4, the opening-closing member 7 is moved from the front position P4 to the rear position P3 through the contraction of the opening-closing-member-moving mechanism 8 in the front-rear direction. The first contact-move member 6L and the second contact-move member 6R are held at the grabbing position P1 by the position of the coupling member 5 being held in the front-rear direction. The processing blade 11 is held in the opening-closing-member-insertion hole 2c by the position of the processing input shaft 12a of the processing-blade-moving mechanism 12 being held in the front-rear direction. The end effector 1 thereby changes the first contact-move member 6L and the second contact-move member 6R into the open state in which they are located apart from each other at the grabbing position P1.

<Contact-Move-Member-Moving Space S1>

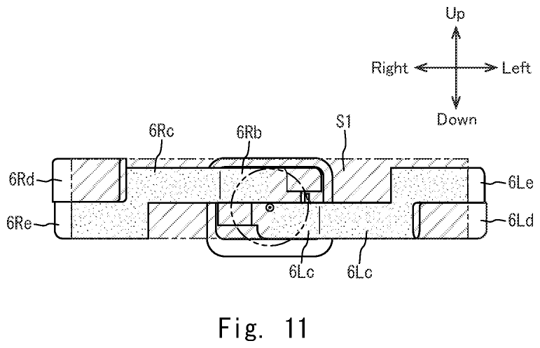

A contact-move-member-moving space S1 of the end effector 1 will now be described with reference to FIGS. 10 and 11. FIG. 10 is a perspective view of the contact-move-member-moving space S1 in the end effector 1. FIG. 11 is a front view of the contact-move-member-moving mechanism 6 in the contact-move-member-moving space S1 of the end effector 1. The contact-move-member-moving space S1 refers to a space that the first contact-move-member 6L and the second contact-move-member 6R pass through when they move.

As shown in FIGS. 10 and 11, the end effector 1 has the contact-move-member-moving space S1 including a space that, at the grabbing position P1, the first contact-move member 6L and the second contact-move member 6R pass through when moving from a position, at which the members are in the open state, to a position, at which the members are in the closed state while maintaining their own positions in the front-rear direction with respect to the body member 2, and a space that the first contact-move member 6L and the second contact-move member 6R in the closed state pass through when moving from the grabbing position P1 to the processing position P2 (see the pale gray portions).

When the stem G is included in at least a part of the contact-move-member-moving space S1, the end effector 1 grabs the stem G by the first contact-move member 6L and the second contact-move member 6R that move in the contact-move-member-moving space S1, and the opening-closing member 7 (see FIG. 4).

Thus, the end effector 1 has the contact-move-member-moving space S1 that is a space whose area of a cross section perpendicular to the front-rear direction increases in the forward direction, so that highly precise positioning of the end effector 1 with respect to the stem G is unnecessary. When the stem G is present in the contact-move-member-moving space S1, the end effector 1 can grab the stem G and position the stem G at the processing position P2 by the first contact-move member 6L, the second contact-move member 6R and opening-closing member 7, without moving the entirety of the end effector 1 by the work machine, such as a multi-joint robot arm, that moves the end effector 1 (see FIG. 5).

As described above, the first contact-move member 6L extends from the proximal end portion of the first extending portion 6Lb located at the right of the reference line D toward the left of the reference line D. The second contact-move member 6R extends from the proximal end portion of the second extending portion 6Rb located at the left of the reference line D toward the right of the reference line D. The inclination of each of the first contact-move member 6L and the second contact-move member 6R with respect to the front-rear direction is thereby greater than that of the first and second contact-move members 6L, 6R without intersecting each other. Therefore, the interval between the first claw portion 6Ld and the second claw portion 6Rd in the open state is wider than an interval between the first and second contact-move members 6L, 6R without intersecting each other.

The end effector 1 grabs the stem G present in the contact-move-member-moving space S1, at the grabbing position P1 by the first contact-move member 6L, the second contact-move member 6R and the opening-closing member 7, without drawing the stem G toward the body member 2. Therefore, the end effector 1 can suppress interference with surroundings of the stem G when grabbing the stem G. The end effector 1 draws the stem G to the processing position P2 in a state where the first contact-move member 6L, the second contact-move member 6R and the opening-closing member 7 are at their closest positions to each other. Therefore, the end effector 1 can suppress interference with the surroundings of the stem G when positioning the stem G at the processing position P2.

Thus, highly precise control of an actuator of the work machine that moves the end effector 1 for grabbing the stem G is unnecessary in the end effector 1. Furthermore, in the end effector 1, when the stem G is present in the contact-move-member-moving space S1, it is unnecessary to move the entirety of the end effector 1 in the vicinity of the stem G. This allows the end effector 1 to increase robustness so that the target object can be grabbed and processed even when a condition of a surrounding environment changes, without highly precisely moving the work machine that moves the end effector 1.

The first claw portion 6Ld and the second claw portion 6Rd are located adjacent to each other in the axial direction of the first axis Ax1 when they have grabbed the stem G at the grabbing position P1. The stem G is supported by a rearward-facing side surface of the first claw portion 6Ld and a rearward-facing side surface of the second claw portion 6Rd, so that the stem G is less likely to be slipped from the first contact-move member 6L and the second contact-move member 6R during movement. This allows for increased robustness so that the stem G can be grabbed and processed even when a condition of a surrounding environment changes, without highly precisely moving the work machine that moves the end effector 1.

### OTHER EMBODIMENTS

The embodiment of the present teaching has been described above, but the above-described embodiment is merely an illustrative example of preferred embodiments of the present teaching. Therefore, the present teaching is not limited to the above-described embodiment and the above-described embodiment can be appropriately modified and implemented without departing from the gist of the teaching.

In the embodiment described above, the end effector 1 includes the first contact-move member 6L and the second contact-move member 6R. Alternatively, it suffices that the end effector includes a plurality of contact-move members. It suffices that the end effector includes at least the first contact-move member and the second contact-move member that move in directions orthogonal to the reference line D.

The end effector 1 grabs the target object by the claw-shaped distal end portions of the plurality of contact-move members. Alternatively, it suffices that the end effector can grab and draw the target object by the plurality of contact-move members. The end effector may grab the target object, for example, by methods using a friction force and an adhesive force.

In the embodiment described above, the end effector 1 allows the electric cylinder 3, as an actuator, to operate the target-object-positioning mechanism 4 and the processing mechanism 10. Alternatively, an actuator configured to reciprocate in the front-rear direction suffices. The actuator may be, for example, constituted by a combination of a motor with a belt, a chain, a gear and a link. The actuator of the end effector may be a pneumatically or hydraulically driven actuator.

In the embodiment described above, the end effector 1 allows the electric cylinder 3, as a single actuator, to operate the target-object-positioning mechanism 4 and the processing mechanism 10. Alternatively, the end effector may allow independent, separate actuators to operate a target-object-positioning mechanism and a processing mechanism, respectively.

In the embodiment described above, the end effector is positioned at an arbitrary location by the work machine. As the work machine for moving the end effector, a machine that moves the end effector at an arbitrary location suffices, such as a multi-joint robot arm, and a moving vehicle including an unmanned transport vehicle and an unmanned flight vehicle.

In the embodiment described above, the end effector 1 moves the opening-closing member 7 by the opening-closing-member-moving mechanism 8 that is a link mechanism extending and contracting in the front-rear direction. The end effector 1 also moves the processing blade 11 by the processing-blade-moving mechanism 12 that is a link mechanism extending and contracting in the front-rear direction. Alternatively, it is unnecessary that the opening-closing-member-moving mechanism and the processing-blade-moving mechanism are link mechanisms extending and contracting in the front-rear direction. The opening-closing-member-moving mechanism and the processing-blade-moving mechanism may be constituted by actuators.

In the embodiment described above, the end effector 1 has the first axis Ax1 that is the rotation center of the first contact-move member 6L, and the second axis Ax2 that is the rotation center of the second contact-move member 6R, and these axes coincide with each other. Alternatively, the end effector may have a first axis and a second axis that are different axes. By changing the arrangement of the first axis and the second axis, the end effector can change, e.g., an opening-closing angle and an opening-closing trajectory of the first contact-move member and the second contact-move member to suit, e.g., the shape of the target object.

In the embodiment described above, the first contact-move member 6L and the second contact-move member 6R are configured to rotate with the first axis Ax1 as the rotation center, through the movement of the opening-closing member 7 in the forward direction and in the rearward direction. Alternatively, it suffices that the first contact-move member and the second contact-move member are configured to open and close in the left direction and in the right direction through the movement of the opening-closing member in the forward direction and in the rearward direction. For example, the first contact-move member and the second contact-move member that are formed of elastically deformable spring steel change between open and closed states by elastic deformation.

In the embodiment described above, the end effector 1 applies rotational forces to the first contact-move member 6L and the second contact-move member 6R to move in the direction away from each other by the torsion springs. Alternatively, the end effector may apply rotational forces to the first contact-move member and the second contact-move member to move in the direction away from each other by elastic bodies other than the torsion springs. Alternatively, the end effector may apply rotational forces to the first contact-move member and the second contact-move member to move in the direction away from each other by actuators.

### REFERENCE SIGNS LIST

1 end effector
2 body member
3 electric cylinder
4 target-object-positioning mechanism
5 coupling member
5a moving-member-support shaft
6 contact-move-member-moving mechanism
6L first contact-move member
6La first shaft-receiving portion
6Lb first extending portion
6Lc first guiding portion
6Ld first claw portion
6Le first rib portion
6R second contact-move member
6Ra second shaft-receiving portion
6Rb second extending portion
6Rc second guiding portion
6Rd second claw portion
6Re second rib portion
7 opening-closing member
7a opening-closing-member-coupling portion
7b buffer member
7c first contacted portion
7d second contacted portion
8 opening-closing-member-moving mechanism
9 opening-closing-guide member (guide member for opening and closing)
10 processing mechanism
11 processing blade
12 processing-blade-moving mechanism
13 processing guide member (guide member for processing)
P1 grabbing position
P2 processing position
P3 rear position
P4 front position
Ta processing portion
Cx intersection portion
S1 contact-move-member-moving space

1. An end effector that is movable by a work machine for grabbing a target object, the end effector comprising:
a body member configured to be supported by the work machine;
a target-object-positioning mechanism provided at the body member, the target-object-positioning mechanism including a contact-move-member-moving mechanism configured to make contact with a part of the target object and to position a portion of the target object at a processing position; and
a processing mechanism provided at the body member, and being configured to perform processing on the portion of the target object positioned at the processing position,
wherein
the contact-move-member-moving mechanism includes:
a first contact-move member supported by the body member at a first support portion, the first contact-move member being configured to be movable, with respect to the body member, in an open-and-closed direction, which includes an open direction and a closed direction and which is orthogonal to a front-rear direction, the front-rear direction including
a forward direction from the body member toward the processing position, and
a rearward direction from the processing position toward the body member,
the first contact-move member extending in the forward direction, and
a second contact-move member supported by the body member at a second support portion, the second contact-move member being configured to be movable in the open-and-closed direction with respect to the body member, the second contact-move member extending in the forward direction;
the target-object-positioning mechanism further includes:
a tubular opening-closing member inside which a part of the first contact-move member and a part of the second contact-move member are located, the opening-closing member being supported by the body member, and being configured to be movable in the forward direction and the rearward direction with respect to the body member, the first contact-move member and the second contact-move member,
an elastic member configured to apply a force to the first contact-move member and the second contact-move member to thereby cause a front end portion of the first contact-move member and a front end portion of the second contact-move member to move away from each other, and
an opening-closing-member-moving mechanism configured to move the opening-closing member in the forward direction and the rearward direction between
a rear position, corresponding to which the target object is positioned at the processing position, and
a front position further forward than the rear position;
in a top view of the end effector, the first contact-move member and the second contact-move member intersect inside the opening-closing member at an intersection portion, which is further forward than the first and second support portions;
portions of the first contact-move member and the second contact-move member forward of the intersection portion are pressed to make contact with an inner circumferential surface of the opening-closing member respectively at a first contacted portion and a second contacted portion thereof facing each other, by an elastic restoring force of the elastic member;
the target-object-positioning mechanism is so configured that
the intersection portion shifts in the forward direction with respect to the first and second contact-move members when the front end portions of the first contact-move member and the second contact-move member move in the closed direction in which the front end portions approach each other,
the intersection portion shifts in the rearward direction with respect to the first and second contact-move members when the front end portions of the first and second contact-move members move in the open direction in which the front end portions move away from each other, and
the opening-closing member, when moved from the rear position to the front position by the opening-closing-member-moving mechanism,
moves the front end portion of the first contact-move member in the closed direction to approach the front end portion of the second contact-move member by a force applied from the first contacted portion, and
moves the front end portion of the second contact-move member in the closed direction to approach the front end portion of the first contact-move member by a force applied from the second contacted portion,
to thereby bring the first and second contact-move members into contact with the target object with the intersection portion being shifted in the forward direction with respect to the first and second contact-move members.

2. The end effector according to claim 1, wherein
the first contact-move member includes
a first proximal end portion extending from the first support portion in a direction away from the second contact-move member with the opening-closing member positioned at the front position, and
a first distal end portion extending from a front end portion of the first proximal end portion toward the second contact-move member and intersecting the second contact-move member in the top view of the end effector,
the first contact-move member being so configured that the first support portion is rotatable with a first axis orthogonal to the front-rear direction and the open-closed direction; and
the second contact-move member includes
a second proximal end portion extending from the second support portion in a direction away from the first contact-move member with the opening-closing member positioned at the front position, and
a second distal end portion extending from a front end portion of the second proximal end portion toward the first contact-move member and intersecting the first contact-move member in the top view of the end effector,
the second contact-move member being so configured that the second support portion is rotatable with a second axis orthogonal to the front-rear direction and the open-and-closed direction.

3. The end effector according to claim 1, wherein
the opening-closing member, when moved from the rear position to the front position by the opening-closing-member-moving mechanism, makes contact with the part of the target object together with the first contact-move member and the second contact-move member that are moved by the opening-closing member.

4. The end effector according to claim 1, wherein
the first contact-move member and the second contact-move member are supported to be movable in the forward direction and the rearward direction with respect to the body member,
the target-object-positioning mechanism includes the contact-move-member-moving mechanism for moving the first contact-move member and the second contact-move member in the forward direction and the rearward direction between the front position and the rear position, and
the first contact-move member and the second contact-move member are moved from the front position to the rear position by the contact-move-member-moving mechanism together with the opening-closing member when the opening-closing member is moved from the front position to the rear position by the opening-closing-member-moving mechanism.

5. The end effector according to claim 2, wherein
the first contact-move member includes, at the front end portion thereof, a first claw portion bent toward the second contact-move member,
the second contact-move member includes, at the front end portion thereof, a second claw portion bent toward the first contact-move member, and
with movement of the opening-closing member in the forward direction, the first claw portion and the second claw portion at least partially overlap each other when viewed in an axial direction of the first axis.

6. The end effector according to claim 5, wherein
a rear side surface of at least one of the first claw portion or the second claw portion at least partially overlaps an end surface of the opening-closing member when viewed in the front-rear direction.

7. The end effector according to claim 2, wherein
the first distal end portion includes a first guiding portion curved away from the second contact-move member,
the second distal end portion includes a second guiding portion curved away from the first contact-move member, and
when the opening-closing member is moved with respect to the first contact-move member and the second contact-move member, the first guiding portion makes contact with the first contacted portion, and the second guiding portion makes contact with the second contacted portion.
